(19) United States
(12) Patent Application Publication
(10) Pub. No.: US 2014/0304335 A1
(43) Pub. Date: Oct. 9, 2014

(54) SYSTEMS AND METHODS FOR INTERACTIVE EXPERIENCES AND CONTROLLERS THEREFOR

(71) Applicant: TIMEPLAY ENTERTAINMENT CORPORATION, Toronto (CA)

(72) Inventors: Elkin Ng Fung, North York (CA); Jonathan Ira Hussman, Toronto (CA); John Andrew Race, Los Angeles, CA (US)

(21) Appl. No.: 14/249,980

(22) Filed: Apr. 10, 2014

Related U.S. Application Data
(63) Continuation of application No. PCT/CA2012/000938, filed on Oct. 11, 2012.
(60) Provisional application No. 61/545,984, filed on Oct. 11, 2011.

(51) Int. Cl. H04L 29/06

(52) U.S. Cl. CPC H04L 65/403
USPC 709/204

(57) ABSTRACT

Methods and systems for providing an interactive experience to two or more participants located at one or more interactive nodes. The described systems include a coordination node and a plurality of interactive nodes. The interactive nodes may be a public node, a private node or an individual node. At each node, participants in interactive experiences are able to view a main or shared display and a personal or private display. The describe methods allow participants to use a plurality of participant devices at various interactive nodes to participate in coordinated interactive experiences. Each participant is able to view a main display that may be shared with other participants and a personal display that may be at least partially specific to the participant.

### FIELD

The described embodiments relate to systems for coordinating and synchronizing interactive experiences shared between participants located at one or more locations. Some of the described embodiments relate to user interfaces for interactive experiences.

### BACKGROUND

Gaming, educational and other shared experiences are increasingly delivered to people through networked computer systems. Some existing systems allow participants in shared experiences to simultaneously observe common information and other graphical elements at different locations simultaneously. Other systems allow the delivery of survey questions and other simple interactive elements in a shared experience. However, these elements are typically delivered to all participants identically. In some systems, participants may be able to make simple inputs to the system based on the common display shown to all participants. The individual inputs from different participants are processed by the system and some rudimentary confirmation or response to the individual inputs may be provided, typically on the shared common display. However, these systems do not provide a customized experience for individual participants incorporating personalized displays and information for different participants. Furthermore, these systems typically allow only a small number of participants to use the system at a location, typically in the range of 10 or fewer participants.

Accordingly, there is a need for systems and methods that allow an interactive experience to be shared among participants located in one or more places, while allowing the participants to participate in a personalized or customized manner. For example, there is a need for gaming systems that allow players to access a customized display of personal or private information or use personal input devices to participate in the otherwise shared experience. In addition, there is a need for systems and methods that provide a customized or individualized experience for the participants as they participate in the interactive experience.

### SUMMARY

In a first aspect, some embodiments according to the invention provide a system with a plurality of nodes. The system includes a coordination node and a plurality of interactive nodes. Each interactive node is at a venue, which may be a public venue, a private venue or an individual venue. At each node, participants in interactive experiences provided by the system are able to view a main or shared display and a personal or private display. The main display at each interactive node contains information that is shared between some or all of the participants at the various interactive nodes. Each participant's personal display includes information that is specific to the participant and may also include other information, including information that is also displayed on a main display or on other participant's personal displays.

Some of the interactive nodes may include a local controller that communicates with the coordination node and one or more participant devices that communicate with the local controller. The local controller controls the main display at each such node. The local controller provides an interface between the participant devices and the coordination node.

Some interactive nodes may include special purpose local controller that is intended primarily or solely for use within the system. For example, an interactive node at a public venue or location may include a purpose built local controller designed to communicate with a plurality of differing participant devices that include a screen on which the personal display may be shown. The participant devices may communicate with the local controller using a proprietary or non-proprietary protocol, or both.

Other interactive nodes may use a multi-purpose local controller, such as a gaming console, television adapter, television or satellite set-top-box, computer or any other processing device. Such a local controller may communicate with participant devices including differing participant devices and potentially including purpose built participant devices that communicate with the local controller using a proprietary or nonproprietary protocol or both.

Some interactive nodes are individual nodes in which a participant uses a single personal device that acts as both a local controller and as a participant device. A main display and a personal display are shown to the participant. In various embodiments, the main display and the personal display may be shown simultaneously or alternatively.

In some embodiments, some or all of the local controllers may be virtual local controllers that are instantiated at an interactive node or at a different location that is accessible to participant devices at the interactive node through a communication network. For example, the virtual local controller an interactive node may be an instance of a software object, computer program or a computer program product that is installed and operated on a computing device that is accessible to participant devices at the interactive node. The virtual local controller may operate on a computing device that is at a location remote from the venue of the interactive node, but which is accessible to participant devices at the interactive node through a network. In some embodiments, the virtual local controller may operate on a computing device at the location of the central coordination node. In some embodiments, the virtual local controller may operate on the same computer device or computing system and the central coordination node of the system. In some embodiments, the virtual local controller may effectively be integrated with the coordination node such that there is no independent local controller, but rather a coordination node that communicates with a plurality of participant devices and also coordinates and synchronizes an interactive experience shared by participants using the participant devices.

Any particular embodiment may include one or more interactive nodes. The various interactive nodes may have the same configuration or may have different configurations.

The participants participate in a shared interactive experience that is coordinated for the participants by the system. The participant devices, local controllers and coordination node communicate through the exchange of messages. The messages include program update messages that provide information relating to participant inputs and updates describing changes in the state of the interactive experience. The messages synchronize the interactive experience allowing the actions of one participant to affect the experience of other participants.

In some embodiments, the actions of a participant may not affect the experience directly, but may be taken into account by the system in delivering a personalized experience to each participant.

In another aspect, there are provided one or more configurable controller that may be used for interactive experiences. Each controller includes one or more controller interfaces that may be suitable for use with a variety of participant devices. Each controller interface may be adapted for use with the particular input devices, sensors and other features and characteristics of a particular type of device. The controller also includes one or more configuration files that may be used to configure a controller interface to operate in a particular manner, which may be suitable for use with one or more interactive experiences. Some configuration files may include a plurality of configurations that may be used during different parts of an interactive experience. Some controllers may be configured to allow a participant to personalize or customize a controller interface for the participant's use during an interactive experience.

In some embodiments, multiple controllers may be operable on a participant device simultaneously and a participant may be provided with inputs to select between controllers.

These and other aspects are further identified and described below.

### BRIEF DESCRIPTION OF THE DRAWINGS

Various embodiments of the present invention will now be described with reference to the drawings, in which:

FIG. 1 illustrates a first multiple location interaction system;

FIG. 2 illustrates a public multi-participant interactive node;

FIG. 3 illustrates a private multi-participant interactive node;

FIG. 4 illustrates an individual interactive node;

FIG. 5 illustrates a primary display;

FIG. 6 illustrates a coordination node;

FIG. 7 illustrates a main display;

FIG. 8a illustrates a personal display corresponding to the main display of FIG. 7 according to an example embodiment;

FIG. 8b illustrates a personal display corresponding to the main display of FIG. 7 according to another example embodiment;

FIG. 9 illustrates messages transmitted in the system;

FIG. 10 illustrates a method of operating the system;

FIG. 11 illustrates a multiple location interaction system according to an example embodiment;

FIG. 12 illustrates a multiple location interaction system according to another example embodiment;

FIG. 13 illustrates a button controller;

FIG. 14a illustrates a screenshot of a button controller configured according to an example embodiment;

FIG. 14b illustrates a screenshot of a button controller configured according to another example embodiment;

FIG. 15a illustrates a screenshot of a button controller configured according to another example embodiment;

FIG. 15b illustrates a screenshot of a button controller configured according to another example embodiment;

FIG. 16 illustrates an interaction system incorporating the button controller;

FIG. 17a illustrates a screenshot of a toss controller configured according to an example embodiment;

FIG. 17b illustrates a screenshot of a toss controller configured according to another example embodiment;

FIG. 17c illustrates a screenshot of a toss controller configured according to another example embodiment;

FIG. 17d illustrates a screenshot of a toss controller configured according to another example embodiment;

FIG. 18a illustrates a screenshot of a toss controller according to a different example embodiment;

FIG. 18b illustrates a screenshot of a toss controller according to a another example embodiment;

FIG. 18c illustrates a screenshot of a toss controller according to a another example embodiment;

FIG. 19a illustrates a gyroscope controller according to an example embodiment;

FIG. 19b illustrates a gyroscope controller according to another example embodiment;

FIG. 20 illustrates an interaction system and several controllers;

FIG. 21a illustrates an interaction system comprising an augmented reality controller according to an example embodiment;

FIG. 21b illustrates an interaction system comprising an augmented reality controller according to another example embodiment;

FIG. 22 illustrates an example embodiment of an interaction system comprising an operator console;

FIG. 23 illustrates another example embodiment of an interaction system comprising an operator console; and

FIG. 24 illustrates another example embodiment of an interaction system comprising an operator console.

### DESCRIPTION OF EXEMPLARY EMBODIMENTS

It will be appreciated that numerous specific details are set forth in order to provide an understanding of the exemplary embodiments described herein. However, it will be understood by those of ordinary skill in the art that the embodiments described herein may be practiced without these specific details. In some instances, well-known methods, procedures and components have not been described in detail so as not to obscure the embodiments described herein. Furthermore, this description is not to be considered as limiting the scope of the embodiments described herein in any way, but rather as merely describing the implementation of several example embodiments.

The embodiments of the systems and methods described herein, and their component nodes, devices and system, may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device.

For example and without limitation, the various programmable computers may be a personal computer, laptop, tablet, personal data assistant, cellular telephone, smartphone device, UMPC tablets and wireless hypermedia device or any other data processing or computing device. Program code is applied to input data to perform the functions described herein and generate output information. The output information is applied to one or more output devices, in known fashion.

Each program is preferably implemented in a high level procedural or object oriented programming and/or scripting language such as Flash or Java, for example, to communicate with a computer system. However, the programs can be implemented in assembly or machine language, if desired. In any case, the language may be a compiled or interpreted language. Each such computer program is preferably stored on a non-transitory storage media or a device (e.g. ROM or magnetic diskette) readable by or accessible to a general or special purpose programmable computer, for configuring and operating the computer when the storage media or device is read by the computer to perform the procedures described herein. In various embodiments, the computer program may be stored locally or at a location distant from the computer in non-transitory storage media. In some embodiments, the computer program may be stored on a device accessible through a local area network (LAN) or a wide area network such as the Internet. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, network based storage and the like. The computer useable instructions may also be in various forms, including compiled and non-compiled code.

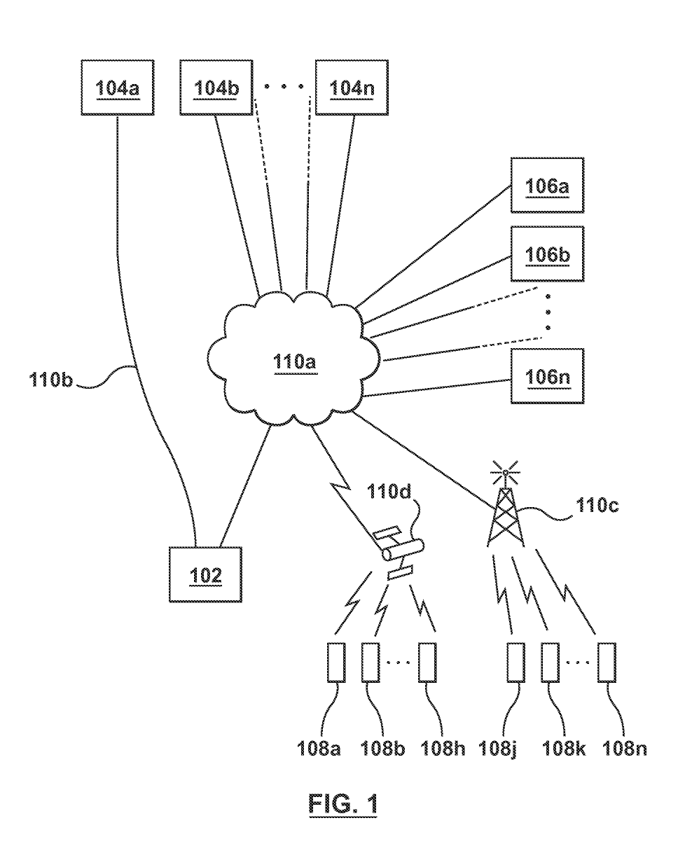

Reference is first made to FIG. 1, which illustrates a multiple location interaction system 100. Interaction system 100 includes a coordination node 102, a plurality of public multi-participant interactive nodes 104, a plurality of private multi-participant interactive nodes 106, and a plurality of individual interactive nodes 108. Each interactive node 104, 106, 108 in system 100 communicates with coordination node 102 through network 110, which may include any type of communication network or network components, such as wide area network 110a such as the Internet, a direct point-to-point connection 110b, a cellular communications network 110c, a satellite based communication network 110d, a local area network or any other type of communication network or system. In some embodiments, some of the interactive nodes may communicate directly between themselves through network 110.

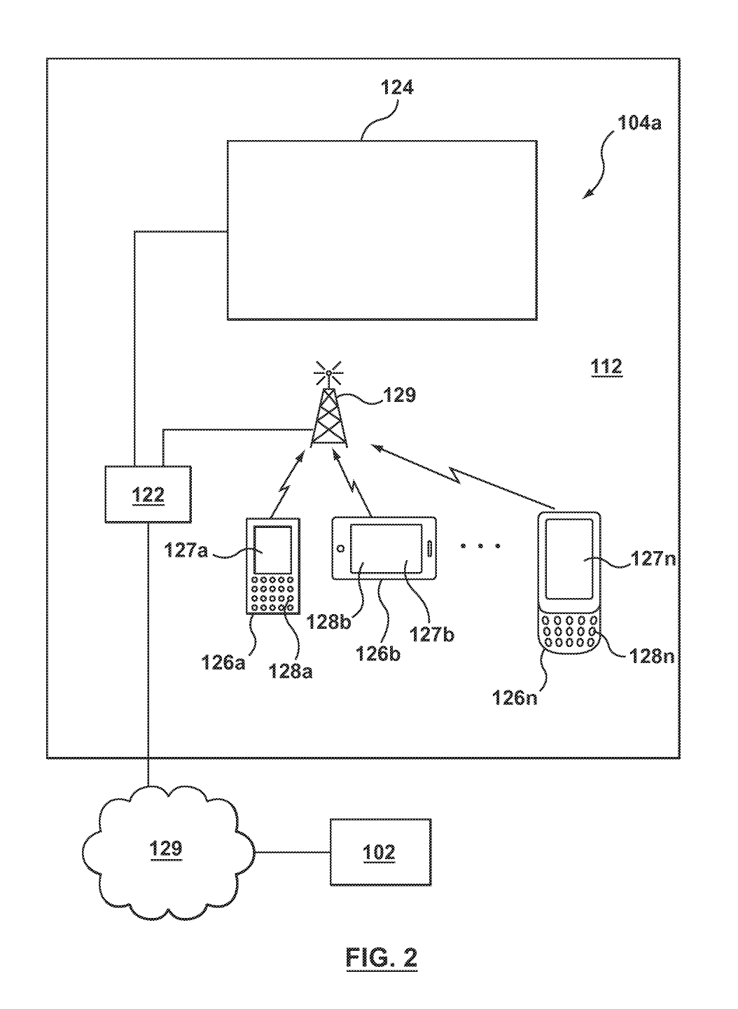

Reference is next made to FIG. 2, which illustrates public multi-participant interactive node 104a. A multi-participant interactive node 104 may also be referred to as a public node. Public node 104a is located in a public location or venue 112. Public node 104a includes a local controller 122, a primary display screen 124 and a plurality of participant devices 126. Local controller 122 is coupled to coordination node 102 directly or indirectly through network 110. A local network 129 is available at public location 112. In this embodiment, local network 129 is a wireless network such as a Wi-Fi network, a Bluetooth network or any other type of communication network or system.

Typically, each participant device 126 will be a portable wireless computing device. Each participant device 126 includes a secondary display screen 127 and one or more input devices 128 such as a keypad, keyboard, touchscreen, button, scroll wheel, scroll ball, gyroscope, accelerometer, compass, level, orientation sensor, voice controller or a combination of such devices. Each participant device 126 is coupled to local controller 122 through local network 129. The participant devices 126 may be different devices, such as various multi-purpose devices such as smartphones, cell phones or other portable computing devices, which are typically coupled to the local controller through wireless communication components of local network 129.

In other embodiments, the participant devices may be wired devices that are physically coupled to the local controller 122 through wired communication components of local network 129. Some participant devices may be mounted in a fixed position or fastened to a fixed location in the public location. For example, some participant devices may be secured to a seat or table to prevent theft of the participant devices. Such physically anchored or tethered participant devices may be coupled to the local controller through wired or wireless communication components of local network 129.

Primary display screen 124 is also coupled to local controller 122, which controls the display of data on the primary display screen 124. The primary display screen 124 is used to present a main display of information to all participants and to observers present in the public location. Local controller 122 is configured to control the display of information on the primary display screen 124 and on each of the participant devices 126. In some embodiments, there may be two or more primary screen positioned to allow participants and other persons in the venue to view one or more of the primary screens. Identical or similar main displays will typically be shown on all of the primary displays.

As used herein, the term “coupled” means that two or more devices are able to communicate such that data and other information can be transmitted between them. The coupling may be a physical coupling through cables, communications networks and devices or other devices. The coupling may also be a wireless coupling through a wireless communication protocol or a network. The coupling may also incorporate both physical and wireless couplings.

Public location 112 may be any location in which a plurality of members of the public may be present and view the primary display screen 124 such as a movie theatre, sporting facility, bar, restaurant or any other location in which a primary display may be visible to members of the public. Local controller 122 may be part of one or more public nodes 104 at a public location 112. For example, if the public location is a movie theatre having multiple auditoriums, some or all of the individual auditoriums may have a public node. The movie screen at the front of the auditorium is used as a primary display screen and individual movie viewers may use participant devices to view individual information on a secondary screen to provide inputs. A public node is provided in each auditorium. The local controller for the various public nodes in the various auditoriums may be shared between two or more public nodes.

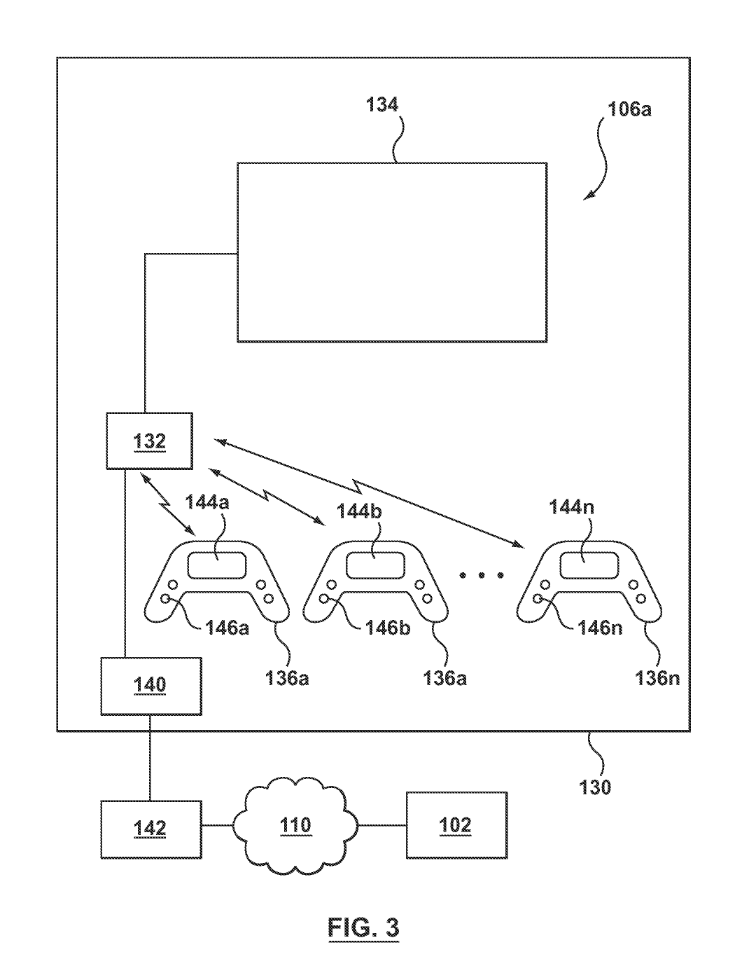

Reference is next made to FIG. 3, which illustrates a private multi-participant interactive node 106a, which may also be referred to as a private node. Private 106a is located in a private location 130, such as a private home. Private node 106a includes a local controller 132, a primary display screen 134 coupled to the local controller 132 and a plurality of participant devices 136.

Local controller 132 is coupled to coordination node 102 through a local private location network 140, which, in this embodiment, is a wireless network, and through an ISP network 142 and network 110. ISP network 142 provides Internet access to devices such as the local controller 132 located at the private location 130. In other embodiments, the local controller 132 may be coupled to coordination node 102 through a wired coupling or through any other means for coupling computing devices.

Local controller 132 is also coupled to the participant devices 136. In a private node 106, the local controller 132 and the participant devices 136 may be designed specifically to interoperate with one another. For example, the local controller 132 may be a gaming console and the participant devices may be game controllers for use with the gaming console. For example, the local controller may be a Sony Playstation 3™, a Nintendo Wii™, a Microsoft XBOX 360™ or another such device or console such as a set-top television or satellite communication box or a computer. In other embodiments, the controller may be integrated into a display device such as a television or monitor or into another type of device capable of communicating with the coordination node and with the participant devices. For example, in some embodiments, the local controller may be an Internet television or video service device such as an Apple TV™ and the participant devices may be devices capable of communicating with the television or video service devices such as Apple iPhones™, iPods™ or iPads™.

Each of the gaming consoles or devices is capable of communicating with and receiving inputs from participant devices, which may be game controllers, designed for communication with the respective console or device. Each participant device 136, according to this embodiment, has a secondary display screen 144 and one or more input devices 146. In some embodiments, the participant devices 136 in a particular private node 106 may be essentially identical in construction. That is, the participant devices may have the same physical structure and controls, although the local controller 132 is able to independently communicate bi-directionally with each of the participant devices. In other embodiments, the participant devices may be of different physical structures, configurations or arrangements.

Local controller 132 controls the display of a main display on the primary display screen 134 and of personal displays on the secondary display screens 144 of the participant devices.

In some embodiment, the local controller 132 may be a virtual component that resides in a network or a device that may be coupled to the coordination node 102 and to the participant devices 136. For example, the local controller 132 may be a virtual component operating on a computer at the same location as the coordination node or at another location. In some embodiments a virtual controller may be shared between different interactive nodes that are in different locations.

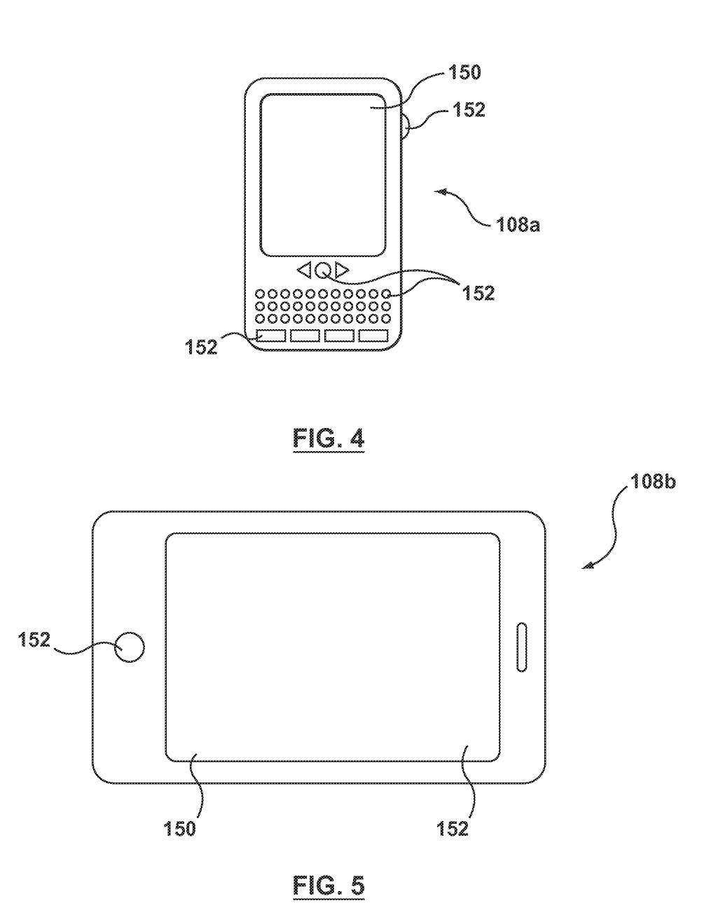

Reference is next made to FIG. 4 and FIG. 5, which illustrate individual interactive nodes 108a and 108b. An individual interactive node may also be referred to as an individual node. Typically, each individual node is a self contained device with a display screen 150 and one or more input devices 152. In some embodiments, some individual nodes may be multi-unit devices that are coupled together and work as an integrated unit having a display screen 150 and one or more input devices 152.

Each individual interactive node 108 is configured to operate as both a main display and as a participant device. In this specification, the term “participant device” includes an individual interactive node, unless specified otherwise, or unless dictated otherwise by the context.

The display screen 150 of an individual node 108 is used as both a primary display screen and as a secondary display screen. For some individual nodes or in some interactive experiences, this may be done by selecting a portion of the display screen 150 in which to display a main display (corresponding to the main display shown on primary display screens at public and private nodes) and a portion of the display screen 150 in which to display a private display (corresponding to the secondary display screens of participant devices used in public and private nodes). In some individual nodes or some interactive experiences, this may be done by displaying a main display on the display screen 150 at some times and a personal display on the display screen 150 at other times. A participant may be able to select between the main and personal displays. The two techniques may be combined in some individual nodes or some interactive experiences.

Individual node 108a has a variety of input devices 152 including a keypad, a control wheel, a control ball and various other buttons. Individual node 108b has several input devices 152 including a button and a touchscreen. Individual node 108b also has an orientation or tilt sensor that allows a participant to provide inputs by tilting or rotating the device and accelerometers that allow a participant to provide inputs by moving the device.

Each individual node 108 is coupled to the coordination node 102. In FIG. 4, individual node 108a is a smartphone that has wireless data service provided by a wireless communication service provider. Individual node 108a is coupled to a wireless communication network which is coupled to network 110.

The public nodes 104, private nodes 106 and individual nodes 108 may be referred to collectively as interactive nodes. In system 100, each interactive node is coupled to coordination node 102, although the communication networks and modes through which the interactive nodes are coupled to the coordination node 102 may vary.

System 100 allows participants using a variety of participant devices 126, 136, 108 to interactively participate in a shared experience. For example, system 100 may be used to allow participants to engage in a shared gaming, presentation, marketing, training, surveying or other interactive experience.

In some embodiments, system 100 is configured as a gaming system. In such configurations, a game is played by participants in at least two locations. At each location, each participant can view at least two displays: a main display that displays shared information and a personal display that includes information that is personal to the corresponding participant.

For example, the game may be a car racing game. An overhead view of a race track may be shown on the main display. Each participant controls one car that moves along the track. The participant can also view information specific to that participant's car or performance in the race on a personal device. For example, a participant's personal display may show the participant car and the track from the perspective of a driver inside the car. The participant's display is shown on a participant device, which also allows the participant to steer the car and to provide other inputs for the car racing game.

In some embodiments, system 100 may be configured as a betting or wagering system. The main display at each interactive node is used to display a video presentation such as a sporting event, a roulette wheel or a card dealer. Participants may view a variety of betting options on the personal display on their personal participant devices and may make bets on events in the video presentation. For example, participants may be able to bet on the outcome of the sporting event or events that occur during the sporting event (such as the next team to score, the next penalty, the outcome of the next play, etc.), the next number to be drawn at the roulette table, a card or hand to be dealt by the card dealer. Each participant is able to independently and privately access information about possible bets, make such bets, receive results for such. Individual betting may be reflected in updates to odds for some bets or to display bets or the outcomes of bets placed by participants.

In some embodiments, system 100 may be configured as an educational system or training system. Information may be presented to a group of participants at several locations. Each participant may view shared information presented on a main display and may also view private information on a personal display.

For example, in a training system, a series of slides may be presented to all participants on the main display that is shown to all participants. Some or all of the participants may also be presented with content specific to each respective participant on the personal display such as a series of questions that each participant must answer. The personal display may allow participants to view and answer questions at the participants own pace, or may display different questions to different participants. The personal display is shown on a participant device to each player, who may use input devices on the participant device to answer questions or otherwise interactively participate in the training session.

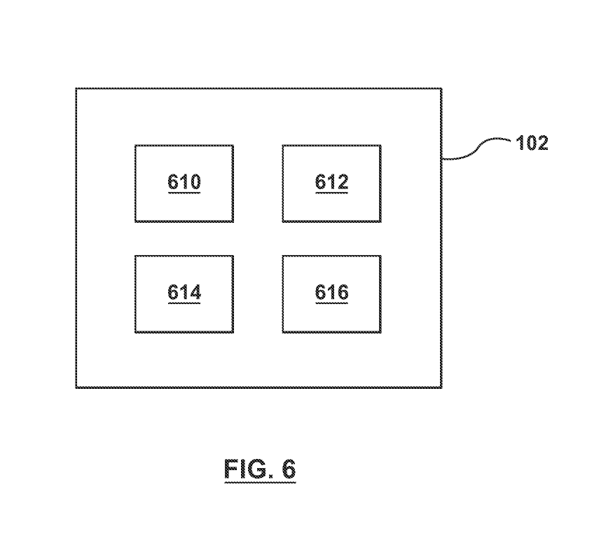

Reference is next made to FIG. 6, which illustrates coordination node 102. Coordination node 102 includes a program database 610, a participant database 612, one or more program control modules 614 and one or more system access applications 616.

A plurality of interactive programs are recorded in the program database 610. The interactive gaming and educational experiences described above are examples of experiences that may be provided by the interactive programs recorded in the program database 610. Each interactive program includes participant components that operate at the participant devices 126, 136 and 108 and may include central or core components that may operate at the coordination node. In addition, some interactive programs may include local controller components that operate at some or all of the local controllers of the public and private nodes. Each of the participant components, central components and local controller components are software objects or components that are executable on the respective devices on system 100.

Program control modules 614 operate within the coordination node 102 to coordinate a shared experience between participants located at various interactive nodes. Typically, each program control module 614 is a software object or component that executes on a processor within the coordination node. The processor has access to a non-transitory memory in which the program database 610, participant database 612 and system access applications 616 are recorded. One or more program control modules 614 may be active at any time to manage the operation of one or more interactive experiences.

System access applications 616 are software objects or components that are installed and operate on different participant devices. Each system access application allows a participant to use the respective participant device to view a personal display on a participant device and to provide inputs using input devices on the participant device. In some embodiments, different system access application may be provided for different participant devices or for the use of participant devices in different interactive nodes. For example, system access applications that operate on a Blackberry™ smartphone may differ from system access applications that operate on an Apple™ iPhone™ smartphone. Different system access applications may be provided for use of a particular smartphone (or other participant device) in different modes. For example, a different system access application may be operated on a participant device when the participant device is used as part of a public node 104, as part of a private node 106 or as an individual node 108. In some embodiments, a single system access application 616 may include modules and components that allow the system access application to operate in more than one mode.

A system access application 616 for use on an individual node 108 may include separate local controller software components that operate the individual node as a local controller and separate participant software components that operate the individual node as a participant device. The two distinct groups of software components may operate simultaneously and communicate with one another in the manner described herein in relation to local controller and participant devices at other interactive nodes. In other embodiments, a system access application for use at an individual node may include integrated software components that operate the individual node such that it communicates with the coordination node as a local controller and allows a participant to use the device as a participant device in an integrated manner.

The system access application 616 at an individual node 108 may produce a main display that is displayed as an alternative to or in conjunction with a personal display. The system access application may also provide control and communication services between the individual node 108 and the coordination node 102.

A plurality of participant records are stored in the participant database 612. In some embodiments, each participant that participates in an interactive experience using system 100 may be required to create an account or profile that is stored in a participant record. The participant records may include identification and authentication information; demographic and personal information about the participant; and program experience information for recording a participant's past success or progress in one or more programs.

Identification and authentication information may be used to allow a participant to securely access the participant's record.

Demographic and personal information may be used to provide personalized information to a participant. A participant may receive information on the participant's personal display based on the participant's previous performance in an interactive experience or based on the demographic or status information about the participant. For example, in an educational interactive experience directed to teaching employees about a new company initiative, various employees in various company and other locations. At each location, employees view common information on a main display. Each employee may receive customized information about the initiative in a personal display, based on the department in which the employee works.

Each program control module 614 manages one ongoing interactive experience at a time. Interactive nodes 104, 106 and 108 communicate with a program control module 614 to participate in the interactive experience. In other embodiments, a single program control module may manage more than one simultaneous ongoing interactive experience.

The operation of system 100 will now be explained with reference to an example gaming configuration of the system. The particular example is a car racing game in which individual participants at various public nodes, private node and individual nodes each control a virtual car as it moves around a track. Different cars controlled by different participants race around a track and the first participant to manoeuvre his or her virtual car around the track is the winner of the race.

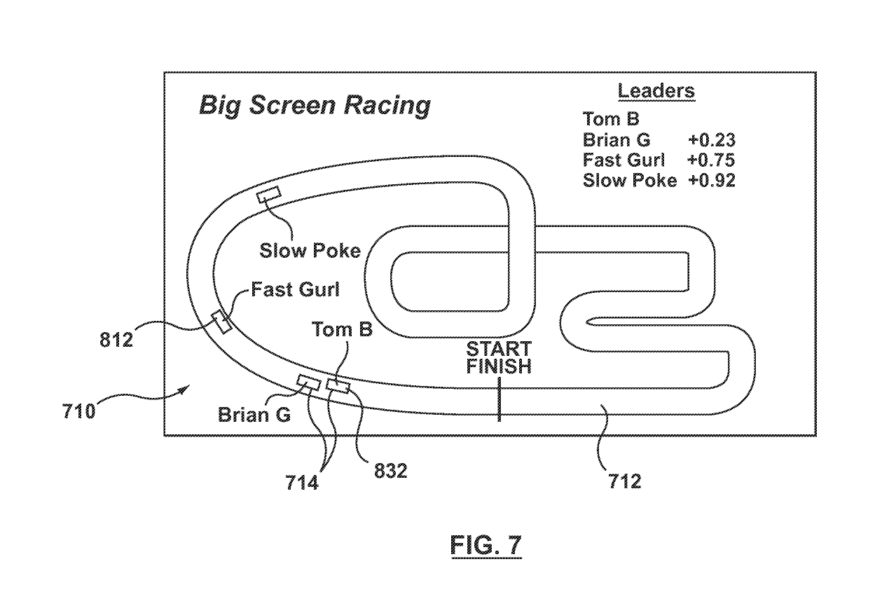

Reference is made to FIG. 7. During a multi-participant interactive experience, each player may view a main display and a personal display. Each main display at each public node or private node is shown on the primary display screen of that node. FIG. 7 illustrates an example main display 710 for the example car racing game. Main display 710 includes an overhead track display 712, a plurality of cars 714 positioned along the track and a participant list 716 identifying the order in which the participants are placed at any point during or at the end of a race. The main display may vary from one interactive node to the next. However, each main display will show at least some common information relating to the interactive experience in which the participant is engaged. For example, each main display may include the information shown in FIG. 7. Some or all of the main displays may further include information that is specific to the venue at which the respective interactive node is located. For example, if a public interactive node 104 is located in an auditorium of a movie theater, then the main display shown on the primary display screen of the node (typically the movie screen in the auditorium) the main display in the particular auditorium may include information relating to the next movie that will play in the auditorium, advertisements for concessions and services available at the movie theater, instructions for participating in an upcoming interactive experience and other information, in addition to information displayed at other interactive nodes in the system 100.

For example, in some embodiments, participants or other persons may be able to participate in a text chat, video chat or other interaction using system 100. Some components of the interaction may be displayed on the main displays shown at the interactive nodes. For example, text chat or instant messages sent by participants or other persons may be displayed. In some embodiments, text chatting or other services may be provided as a second interactive program contemporaneously with a first interactive program and components of both programs may be displayed on some or all of the main displays in the system. Participants in the respective interactive programs use their respective participant devices to participate in the respective interactive experiences.

At the same time, a main display on a private node 106 (FIG. 3) may include information relating to local controller 132 or the participant devices 136 at the particular node. For example, the main display, which is displayed on the primary screen 134 of the private node 106, may include information about the standing of each participant using the private node in the car racing game. As another example, if the participant devices are battery powered, then the strength or status of the batteries in each participant device may be displayed on the main screen.

At each individual node 108 in the system, the respective participant may also view a main display and a personal display. At some individual nodes, the participant may switch the individual node device 108 between a primary display mode in which a main display is shown and a secondary display mode in which a personal display is shown. At some individual nodes, a composite display showing both a primary display and a personal display is shown.

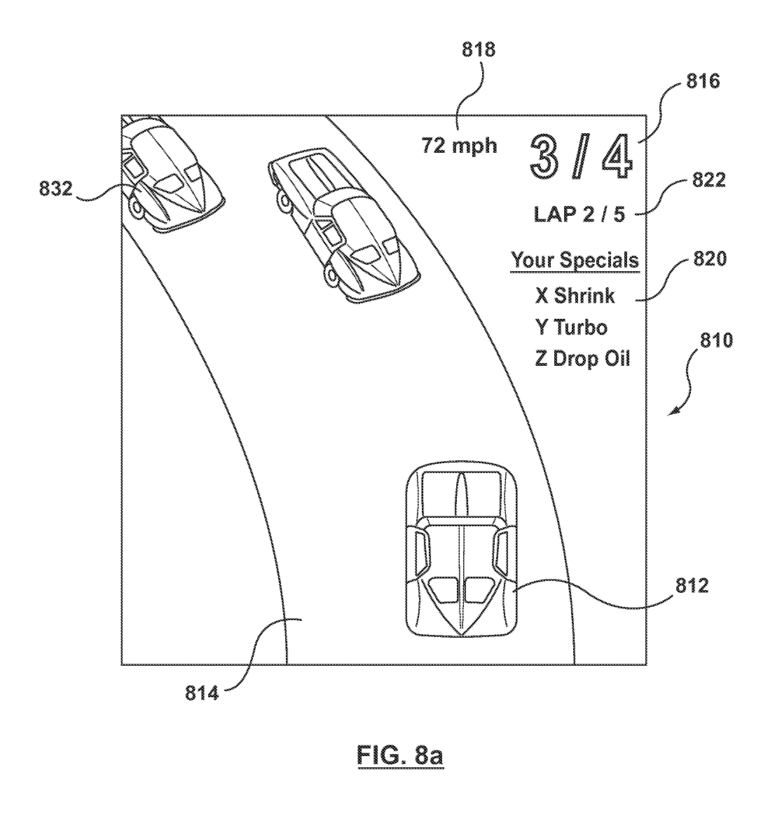

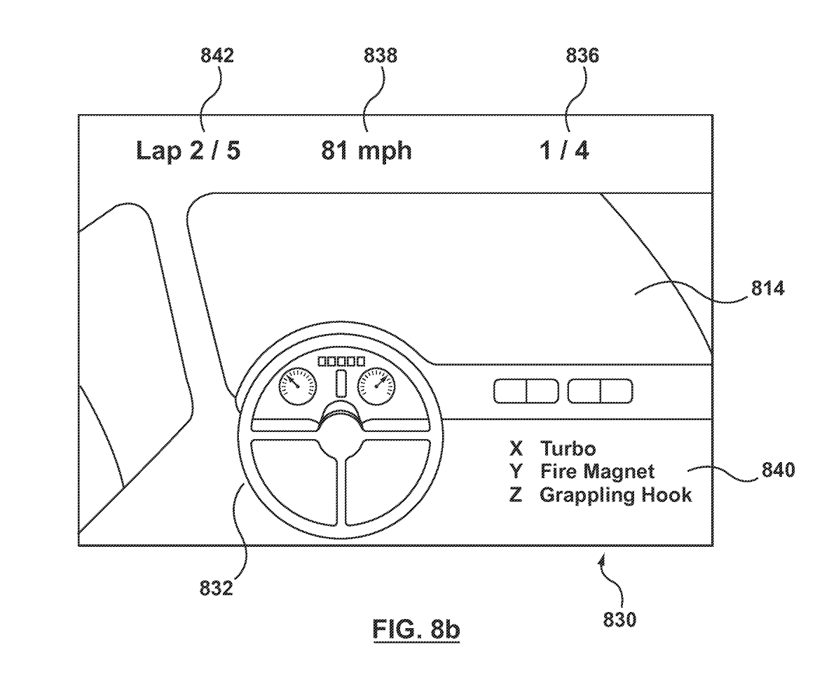

Reference is next made to FIGS. 8a and 8b. FIG. 8a illustrates a first personal display 810 for the example car racing game. Personal display 810 includes an image of a first participant's car 812 in the race, from a viewpoint situated behind the car 812. The first participant can also see the track 814 from the same perspective. The personal display 810 also includes the first participant's position 816 in the race, speed 818 and options 820 the participant may have during the race to accelerate the participant's car or to obstruct other participant's cars.

FIG. 8b shows a different personal display 830 for a second participant in the example car racing game. Personal display 830 includes an image of the second participant's car 832 from an in-car perspective. Personal display 830 also includes the track 814, the second participant's position 836 in the race, speed 838 and options 840 that the second participant has during the race.

During a multi-player interactive experience, a main display is available for viewing by all participants. The specific main display shown to a particular participant may depend on the participant's location. In the case of a participant using an individual node, the main display available to the participant may depend on the participant's device or on the participant's preferences. Such options may be provided by the participant components of an interactive program. For example, some participant components may display a main display together with a personal display on the screen of a participant device. Other participant devices may provide several configurations of a main display that may be displayed based on the participant's preferences. Similarly, local controller components at a private node may provide various alternative formats for a main display at the private node or a public node.

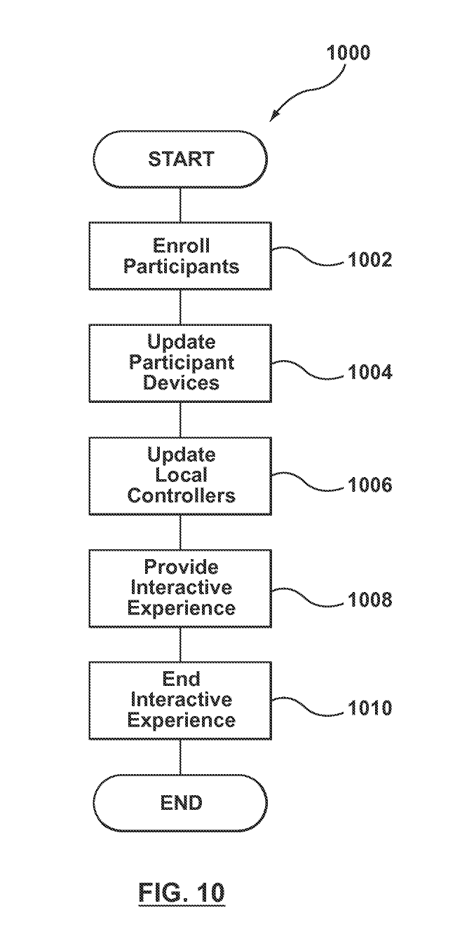

Reference is made to FIG. 10, which illustrates a method 1000 of operating system 100 to provide a shared interactive experience for participants at different interactive nodes.

Method 1000 begins in step 1002, in which a plurality of participants located at two or more locations are enrolled to participate in an interactive experience. To enroll, each participant activates a system access application 616. Participants located at a public or private node may be able to access the respective local controller 122 or 132 for the node using a participant device to download a system access application 616. For example, at a public node 104, instructions for accessing the respective local controller 122 may be displayed on the primary screen 124 of the public node. Participants may use a participant device 126 to access the local controller 122 and then download a system access application suitable for operations on the participant device.

At a private node 106, a system access application 616 suitable for use with the participant devices 136 may be pre-installed in the participant devices prior to their delivery to a retail customer. In some embodiments, a system access application 616 may be downloaded to the local controller 132 of the private node 106, and may then be installed on the participant devices from the local controller 132.

At an individual node 108, a system access application 616 may be installed on the individual node by downloading the system access application 616 from an application store or application service or from a computer or other device to which the individual node device may be coupled.

Each system access application allows a participant to communicate with the coordination node 102.

In a public node 104, the system access application 616 communicates with the coordination node 102 through the local controller 122 of the public node 104.

In this embodiment, in a private node 106, a participant device may not communicate directly with the communication node. Instead, the participant device may communicate only with the local controller 132 of the private node, which then communicates with the coordination node. In some embodiments, a public node 102 may also have this configuration.

An individual node 108 is also a participant device which communicates with coordination node 102 directly (although typically through various communication network elements).

The coordination node 102 maintains a list of currently available interactive experiences during operation of the system 100. Some interactive experiences may be available to all participants, while others are available to participants located only at certain interactive nodes or certain types of interactive nodes. For example, some interactive experiences may be designed to last a relatively long time, exceeding the short period of time that participant in a movie theatre may be waiting before the start of a movie. Such interactive experiences may not be available to participants accessing system 100 from a public node such as a movie theatre. Other participants at public nodes where patrons tend to participate in a shared experience for a longer period, such as participants accessing system 100 from a bar or other social establishment may be permitted to participate in such an interactive experience. At some interactive nodes, all participants may be required to participate in the same interactive experience. For example, at a public or private node that has only a single primary display that is used to show a main display for a single interactive experience, then all participants must participate in that interactive experience. In some embodiments a primary display may be used to show a main display for two different interactive experiences on different parts of the primary screen.

Each participant activates the respective system access application on the participant's device 126, 136 or 108. The system access application obtains a list of currently available interactive experiences from the coordination node 102, based on the interactive node from which the player has accessed the system 100. The list of available interactive experiences available to the participant is displayed on the participant's device and the participant selects one of the experiences, thereby enrolling to participate in the selected interactive experience.

In other embodiments, participants may select an interactive experience directly under the control of their respective local controllers. Interactive experiences available at each interactive node may be recorded (in real time or in advance) in the respective local controller. Participant devices communicate with the local controller to present a list of interactive experiences available to a participant, who may then choose from the list.

Method 1000 proceeds to step 1004, in which any participant components required for the interactive experience are installed on the enrolled participant's device. If the participant's device has not previously been used for the interactive experience, then any participant components necessary for the participant's device to provide the interactive experience are transmitted and installed on the participant's device. If the participant components have previously been installed on the device, then outdated components may be updated with current participant components. The particular participant components installed on a particular participant device may be dependent on the features of the participant device, the particular interactive experience for which the participant has enrolled or both. For example, if a participant device has a touchscreen, an orientation sensor, an accelerometer or other input device, then the participant components installed on the participant device may be designed to allow a participant to use such input devices. The participant components may be transmitted from the coordination node, a local controller or from an asset server coupled to the interaction system.

Method 1000 then proceeds to step 1006, in which the local controller for the interactive node at which an enrolled player will participate in an interactive experience is updated, if necessary. Some interactive programs may include local controller components that operate on the local controllers at the interactive nodes 104, 106 and 108. Typically, although not necessarily, such local controller components may differ depending on the specific type of interactive node in which they will operate. For example, local controller components for a local controller 122 in a public node 104 may be configured differently than local controller components for a local controller 132 such as a gaming console in a private node 106. Similarly, local controller components for an individual node 108 may act as both a local controller and as a participant device and are typically configured for the specific type of participant device on which they will be used.

If the local controller components have not previously been installed on the respective local controller of the interactive node from which the newly enrolled participant has accessed the system 100, then the local controller components are installed. If the local controller components have previously been installed, they may be updated to reflect any changes in the local controller components.

The local controller components for different interactive programs may vary depending on the nature of the interactive program. For example, in the car racing game described above, the local controller components may include information about the virtual tracks and virtual cars in the game. For example, the program components for the racing game may include various core components relating to the control, display and interaction of vehicles that may be used by a participant in a race. Specific details of each vehicle including specific characteristics that may be used by the core components to determine how the specific vehicle is controlled, displayed and how it interacts with other vehicles and other elements of the car racing program. If a new vehicle is added to the program, then local controller components relating to the new vehicle may be uploaded to the local controller in this step. The core components use the new vehicle specific components to display and otherwise use the new vehicle in an interactive car racing interactive experience. The local controller components may also include rules of the game and details of information message that will be exchanged between the coordination node, the local controller and the participant devices. In the case of an educational or survey interactive experience, the local controller components may include questions, slides or other information to be displayed on the main display of the interactive node or to be transmitted to and displayed on the participant devices at a local node.

Steps 1004 and 1006 allow program components for an interactive program to be updated at the local controller and participant devices. These steps are optional and may not be performed in some embodiments. For example, in some embodiments, a participant device may be updated independently of method 1000 in which a participant is able to participate in an interactive experience. Similarly, in some embodiments, local controllers may be updated during periodic updates (such as nightly or weekly updates) to add new components. In other embodiments, a limited number of interactive program components may be transmitted to a participant device during method 1000. For example, if a particular interactive program requires a graphic, computation or other asset or component, the asset may be transmitted to and installed on a participant device.

Different interactive experiences may permit or require a different number of participants to be enrolled. When an appropriate number of participants have enrolled in an interactive experience, method 1000 then proceeds to step 1008, in which the interactive experience is provided to the enrolled participants.

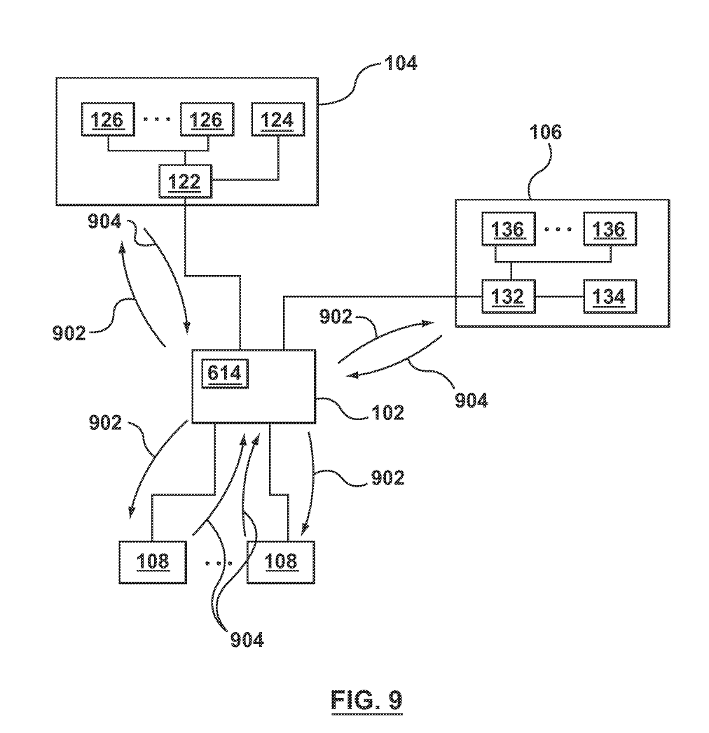

Reference is made to FIG. 9, which illustrates a number of messages used in system 100 to provide an interactive experience. During an interactive experience, a program control module 614 operating within coordination node 602 manages the interactive experience. Program control module 614 ensures that the shared interactive experience delivered to players at different nodes (and to different players at the same node) is synchronized such that inputs from each participant are appropriately displayed on all main displays, when such display is needed, and are taken into account into the delivery of the shared experience to other participants. Depending on the interactive experience, it may be desirable to have the results of inputs from some or all of the participants contemporaneously displayed on the main displays. For example, in a car racing interactive experience, vehicle control inputs, such as acceleration, braking and steering inputs from each player may be shown on the main displays as they are received. In a different interactive experience in which players make decisions in secret from one another, some or all of a player's input may not be reflected on the main screen until an appropriate time in the experience, or perhaps not at all.

The program control module 614 transmits program update messages 902 to each of the interactive nodes 104, 106 and 108 at which a participant in the shared experience is enrolled. The program update messages 902 may include a variety of messages including:
Main display control messages, which instruct the local controller 122, 132, 108 to update the main display of the interactive experience on the primary display 124, 134, 150 of the interactive node.
Interactive experience control messages, which indicate to the local controller or the participant devices or both when a change occurs in the interactive experience. For example, the control message may indicate when an interactive experience starts, stop or transitions from one mode to another. For example, interactive experience control messages may include the state of an interactive experience allowing the state of an experience to be shared and synchronized between interactive nodes. The local controller may update the main display of the interactive experience in the particular interactive node, transmit corresponding control messages to participant devices or respond otherwise to a control message.
Participant device messages, which the local controller re-directs in a modified or unmodified form to a specified participant device.

The program control module 614 also receives participant input messages 904 from the participant devices 126, 136 and 108. The participant input messages are generated based on inputs entered by a participant using input devices at the participant's device.

The participant components provide an interface for the participant to participate in the interactive experience. Depending on the interactive experience, the participant components may permit a participant to change the personal display shown on the secondary screen of the participant's device or to change input controls to those preferred by a participant.

For example, in the car racing game example, the participant components may provide various display perspectives or views from within, behind or ahead of the participant's car in the race. The participant may also be able to see forward ahead of or backwards behind the participant's car. Other views may include an overhead view of the participant's car. Such inputs may be processed entirely by the participant components, which may be configured to generate and provide various personal displays on the participant's devices secondary display.

Other participant inputs may affect the shared interactive experience for other players. For example, some participant inputs may relate to the direction (i.e. a steering input) or speed (i.e. an accelerator input or a braking input). Such inputs affect the position of participant's car in the race. The participant components may process such inputs to modify the personal display on the participant's device. For example, the speed of the virtual car may be updated on the personal display by the participant components. Such inputs, or a variant of such inputs, are transmitted in participant input messages 904 to the local controller 122 or 132. The local controller may also process the participant inputs. For example, the local controller may modify the main display shown on the primary display at the interactive node. The local controller then transmits the participant input message 904 (or a copy or variant) of it to the corresponding program control module 614 in the coordination node 102.

At the coordination node, the program control module 614 receives the participant input message 904, determines the effect of the participant input on the shared interactive experience and takes one or more responsive actions. Such actions may include updating a player profile of the participant from whose participant device the participant input message originated, updating interactive experience information recorded by the program control module to record the state of the interactive experience or generating one or more program update messages 902 that are then sent to local controllers, or a combination of these actions. If the participant input message 904 is not relevant to the interactive experience (for example, where the message is received after the interactive experience has terminated), program control module may discard the participant input message 904.

The program control module may process and react to a program update message 902 from a participant device in various manners, including: —If the participant input affects the main display of the interactive experience at various interactive nodes, the program control module 614 determines the modification required to the main display and transmits a main display control message to the local controller at each interactive node identifying the modification. In various embodiments, the main display control message may identify all of the content of the main display, may identify only components that are to be changed in the main display, or may provide information that allows the local controller at the respective interactive nodes to generate a main display. —If the participant input affects another participant's interactive experience, the program control module 614 transmits a participant device message to the local controller of the interactive node at which the other participant is accessing system 100. The local controller passes the participant device message to the appropriate participant device. The participant device message may provide various types of information to a participant device:
Personal display information that is used by the participant components of the interactive program to render the personal display on the secondary display of the participant's device. Such information may include details of other participant's participation in the interactive experience. In the car racing example, this information may include the position, velocity and acceleration of other participant's cars in the car race, allowing the participant components on the participant's device to render a personal display taking such information into account.
Participant option information, which identifies options that be available to a participant. For example, in the car racing or other gaming interactive experience, if a player completes a milestone in an interactive experience, the player may become entitled to access new options or features in the interactive experience.

An interactive experience is provided to participants primarily in step 1008. Typically, an interactive program ends if certain end-of-experience conditions are met. For example, in a gaming interactive experience, the game may end if a participant or team of participants wins the game, if a selected time period expires or if another end 10 of-experience condition is met. In the case of a survey, educational or other interactive experience in which different participants are viewing a common main screen and independently answering questions or concurrently on a personal display, the experience may end when the participants have answered all of the questions, at the end of a program displayed on the main screen, after a selected time period, when a selected percentage or number of participants have completed a selected percentage or number of questions or other activities. In the case of a betting interactive experience in which the participants are viewing a video program on the common main display and concurrently placing bets based on events shown in the video program, the interactive experience may end when the video program ends.

When the end-of-experience conditions are met, method 1000 proceeds to step 1010. In step 1010, program control module 614 transmits a program update message to all local controllers and to each individual node indicating that the interactive experience is ended. The local controllers transmit a corresponding program update message to each participant device at each public and private node.

The local controller may update the main display to reflect an outcome of the interactive experience. For example, the main display may be updated to identify the winner of a gaming interactive experience, to display a summary of an interactive experience or simply to indicate that the interactive experience has ended.

Similarly, participant components of the interactive program may display the outcome of an interactive experience for the participant, such as a message indicating the end of an interactive experience on the personal display shown on a secondary display screen of a participant device.

During step 1010, some interactive experience control messages may be transmitted only within an interactive node. For example, if an interactive experience control message indicates a change in the state of a game that is relevant only to one participant or only to participants at the interactive node from which the message originates, it may not be transmitted by the local controller of that node to the coordination node. In some embodiments, a local controller may transmit only information that is relevant to the coordination node or to participants at other interactive nodes in an interactive experience control message.

In some embodiments, the local controllers or the coordination node or both may modify interactive program control message such that only information that is relevant to participants at an interactive node is sent to that node. This may reduce the number and size of interactive program control messages, allowing an interactive experience to be synchronized more quickly or with the use of less communication bandwidth or both.

Method 1000 then ends.

Optionally, method 1000 may be performed repetitively, allowing the interactive experience to be repeated.

Method 1000 provides an interactive experience to a plurality of participants located in disparate locations. Each participant shares the same interactive experience and view common information on a main display. Simultaneously, each participant has a personal display shown on the participant's personal device that provides a rich graphical experience that is personal to the individual participant.

Some interactive experiences may permit participants to join or leave an interactive experience while the experience is ongoing. For example, in some betting interactive experiences, such as some poker experiences, participants may be able to join and leave the interactive experience individually, with the interactive experience continuing before and after a particular participant participates in the interactive experience.

In an interactive experience in which a participant may join after the interactive experience has started, a participant may complete steps 1002 and 1004 independently. Step 1006 may not be required in such a situation, particularly if the local controller used by the newly enrolled participant is also in use by other participants.

In an interactive experience in which a participant may leave or be removed from before the interactive ends for other players, a departing participant may move to step 1010 while other participants continue in the interactive experience in step 1008.

In some interactive experiences, a participant device may not require updates in step 1008. For example, in some interactive experiences, all components required for a participant to participate in the experience may be delivered in step 1004 and it may not be necessary to transmit update messages to the participant devices during step 1008. In such experiences, update messages are transmitted to the coordination node based on inputs from participants. The coordination node then transmits corresponding update messages to the interactive nodes allowing the local controllers to update the respective main displays.

Reference is made to FIG. 1. Various embodiments may deliver an interactive experience to participants at specific types of interactive nodes.

In some embodiments, each interactive node may be a public node 104. In other embodiments, each interactive node may be a private node 106. In other embodiments, different combinations of public, private and individual nodes may be permitted.

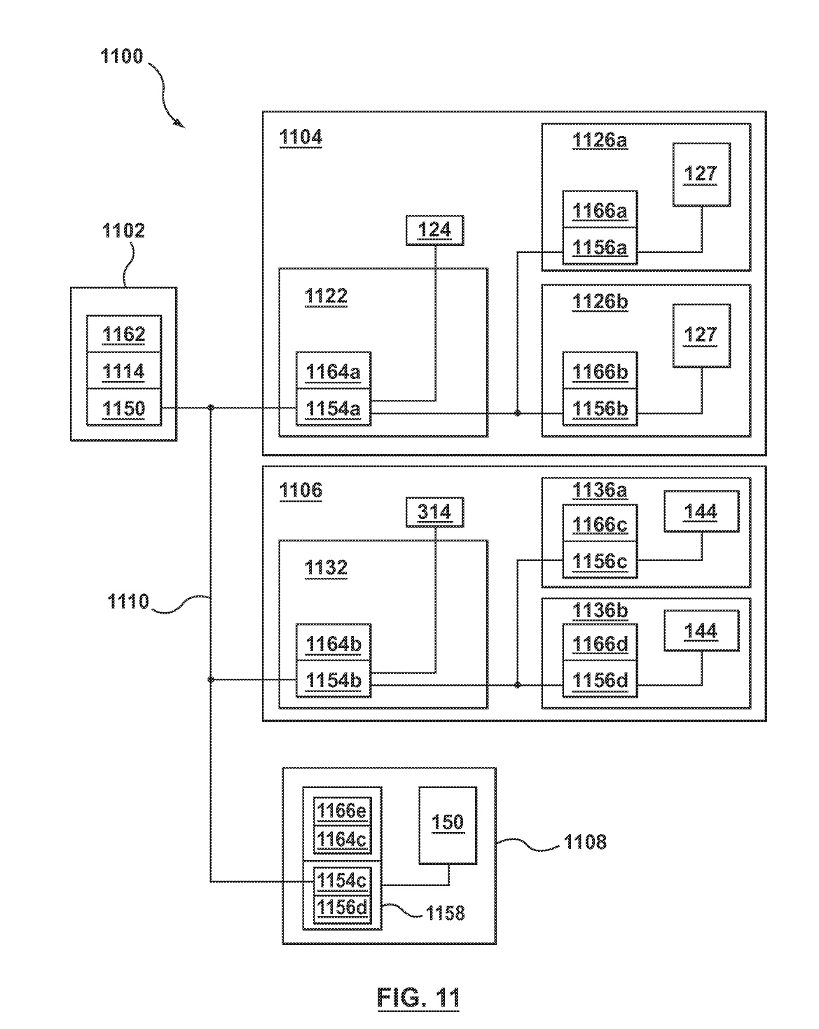

Reference is made to FIG. 11, which illustrates another multiple location interaction system 1100. FIG. 11 illustrates system 1100 from a software architecture perspective. The various nodes and devices of system 1100 are similar in structure and operation to the corresponding nodes and devices of system 100 and corresponding nodes, device and components are identified by similar reference numbers.

System 1100 includes a coordination node 1102, one or more public nodes 1104 (only one of which is illustrated), one or more private nodes 1106 (only one of which is illustrated) and one or more individual nodes 1108 (only one of which is illustrated).

System 1100 includes a coordination framework that includes central coordination components 1150, local coordination components 1154 and participant coordination components 1156.

The interactive programs stored in the coordination node 1102 include central components 1162, local controller components 1164 and participant components 1166.

When system 1100 is used to provide an interactive experience using a particular interactive program, the components of system 100 operate as follows.

At the coordination node 1102, the central components operate with a program control module 1114. The program control module 1114 operates with the central coordination components 1150. The central coordination components of the interactive program provide functions and services that are specific to the interactive experience or to the interactive program. The program control module manages the coordination of the interactive experience for all participants in the interactive experience at the various participant nodes, including management of the main display at each interactive node, the personal display at each participant device and the processing of participant inputs received from each participant device. The central coordination components may provide communication and other services to the program control module 1114 and the central coordination components 1150. In some embodiments, the program control module 1114 may be combined with the central coordination components 1150 such that an integrated program control module provides the functions of both a program control module and the central coordination components.

At each local controller 1122, 1132, local controller components 1164 operate with the local coordination components 1154. The local controller components 1164 provide services and functions that are specific to the interactive experience or the interactive program. The local coordination components 1154 may provide communication and other services. The local coordination components also manage the main display shown on the primary screen in a public or private node.

At each participant device 1126 or 1136, participant components 1166 operate with participant coordination components 1156. The participant components 1166 provide services or functions that are specific to the interactive experience or interactive program. The participant coordination components 1156 may provide communication and other services to the participant components 1166.

Typically, the coordination framework provides coordination services that are common to a plurality of interactive programs. In such embodiments, the interactive programs may rely on the coordination framework for coordination services, allowing developers of the interactive programs to limit interactive programs and their respective components to software, data and other content that is specific to the interactive experience provided by the interactive program. Coordination services that are required by a plurality of interactive programs are provided by the coordination framework. This may reduce the size of the local and participant components that must be installed respectively on local controller and participant devices before an interactive experience can be provided. It may also serve to make interactive experiences more uniform, allowing participants to more easily participate in new interactive experiences using previously acquired knowledge and skills.

A coordination framework may provide various services.

In some embodiments, the coordination framework may provide internode communication services. For example, coordination components 1150, 1154 and 1156 may provide a message or data passing service that allow interactive program components 1162, 1164 and 1166 to communicate with one another. The coordination components communicate with one another. The interactive program components communicate with the respective coordination components installed at the same nodes, and communicate indirectly with one another through the coordination components.

In some embodiments, the coordination framework may provide participant account services. For example, the central coordination components may interface with a participant database stored in the coordination node. The central coordination components may provide details from a participant's account to an interactive application, either directly to a central component or through other coordination framework components to a local controller component or to a participant device component of an interactive program. The interactive program component may use the information from the participant's account to personalize or modify the participant's experience. In addition, the interactive application may provide updated information for a participant's account to the central coordination component to be stored in the participant's account. Such updated account information may be recorded in the participant database.

The coordination framework may also provide account creation services. Participant coordination components installed on the participant devices may include an account creation function. When a participant accesses system 1100 using either a system access application or a participant component of an interactive application, the participant may wish to create an account. The participant coordination components may include an account creation module that collects the information required for a participant account, and then forward such information to central coordination components. The central coordination components may then create a new account for the participant in the participant database.

In some embodiments, the coordination framework may provide device interface services. For example, participant coordination components may interface with input devices built into or attached to a participant device. The participant coordination components may convert various types of inputs received from various types of input devices into a consistent set of inputs that are then provided to the participant components, local controller components and central components of an interactive application. This allows the same or similar participant components to be installed on participant devices regardless of their different input devices. Other differences in the participant devices may still require different participant components to be installed on different participant devices.

In some embodiments, the coordination framework may provide content delivery services that allow content for an interactive experience to be pushed from the coordination node to local controllers and participant devices at interactive nodes. For example, an interactive program may use the coordination framework to push media components for an interactive experience to the interactive nodes at the start of or during an interactive experience.

In some embodiments, the coordination framework may provide participant interaction services. For example, the coordination framework may provide video chat, voice chat, multimedia messaging, social media interfaces (such as an interface to automatically transmit information to or using Facebook™ or Twitter™). In various cases, the participant devices may be configured to access third party assets that are not part of the original interactive experiences. For example, the participant device may be configured to access assets, such as images or pictures, from social media websites. The participant device may also be configured to access assets from the local memory of the participant device. The coordination framework may enable the participants to access third party assets and add them to the interactive experience. In some cases, the participants may select the assets and toss them, for example by using a toss controller as discussed below, onto the secondary display. The coordination framework may provide these inputs to the local controller and the coordination node so that they become part of the interactive experience.

In some embodiments, the coordination framework may provide a reward system. For example, the coordination framework or an interactive application may reward participants for participating or succeeding in various interactive experiences. A participant's interactive experience may be varied based on the rewards earned by the participant. Typically, the participant's earned rewards will be recorded in the participant's account record in the coordination node. The participant's reward status may be provided to an interactive application as described above in relation to account services.

In some embodiments, the reward system may provide coupons, incentives or other information to participants. In some embodiments, participant preferences may be recorded with a player's account. A participant's preferences may be used to provide a more customized experience to the participant, including the provision in-game and other advertising, coupons and other information.

In some embodiments, the coordination framework may provide graphical and physics processing services. For example, the coordination may provide mathematical algorithms and routines that calculate outcomes for events such as collisions, scene management, graphic layering and other processing intensive activities, eliminating the need for the components of an interactive program to include such algorithms and components. Like other services provided by the coordination framework, components of the interactive applications may invoke such services, reducing the need to include such services in the interactive application components.

In some embodiments, the coordination framework may provide positioning services. For example, the participant coordination components in a coordination framework may use positioning devices such as global position system sensors, Wi-Fi (802.11) antennas and other devices built into a participant device to estimate the location of a participant device. The position may be provided to an interactive program to allow a participant's experience to be customized based on the player's location.

In some embodiment various participants may be organized into teams. For example, in the car racing example, participants may be organized into a first team and a second team such that one team wins if a specified condition is met. The program control module in such embodiments tracks the membership of participants in each team. The personal displays shown to members of each team may include information that is relevant to the entire team. In this way, the participants on one team are able to share information that is not provided to the other team. In some embodiments, all participants at a particular node may be on the same team. In such embodiments, the main display shown at the node may include information to be shown to the team.

In systems 100 and 1100, three types of interactive nodes are described: public nodes, private nodes and individual nodes. In some embodiments, only public nodes may be provided. In other embodiments, only private nodes may be provided. In other embodiments, only public and private nodes may be provided. In other embodiments, only individual nodes may be provided. In some embodiments, only public and individual nodes may be provided. In some embodiments, only private and individual nodes may be provided. In each case, a participant at any node is able to see a main display that contains information that is also shown on other main display and a personal display that contains information specific to that participant.

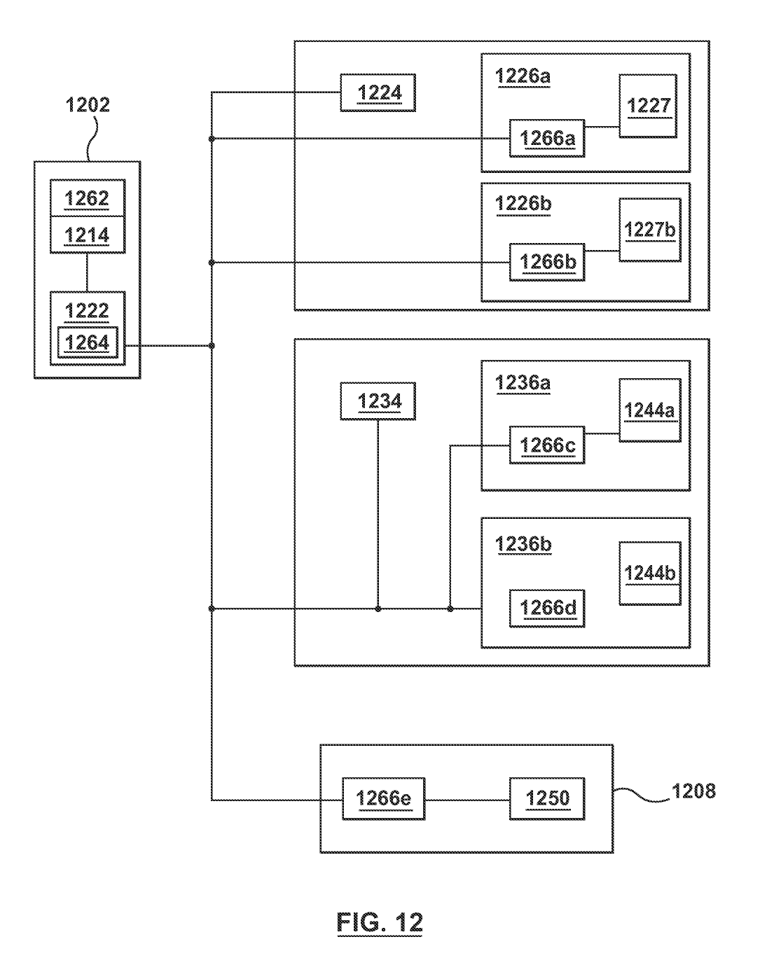

Reference is next made to FIG. 12, which illustrates another multiple location interaction system 1200. Various elements of system 1200 are similar to elements of system 100 and 1100. Corresponding elements are identified by similar reference numerals.

System 1200 includes a coordination node 1202, one or more public nodes 1204 (only one of which is illustrated), one or more private nodes 1206 (only one of which is illustrated) and one or more individual nodes 1208 (only one of which is illustrated).

Public node 1204a does not include a local controller. Coordination node 1202 includes an interactive node controller module 1222. Interactive node controller module 1222 includes interactive node control components 1264. Interactive node control components communicate with a primary display screen 1234a at public node 1204a and also with one or more participant devices 1226. The interactive node control components 1264 provide the functions described above in relation to the local controllers of public nodes 104 and 1104 for public node 1104.

Similarly, private node 1206a does not have a local controller. Instead the interactive node control components in the interactive node control module 1264 provide the functions of a local controller of private nodes 106 and 1106.

Individual node 1208a also does not have local controller components. Instead the interactive node control components 1264 in the interactive node control module 1122 provide the functions of a local controller of individual nodes 108 and 1108.

In system 1200, the interactive node control components 1264 in the coordination node 1202 operate as a virtual local controller for some or all of the interactive nodes in the system. For interactive nodes that utilize the interactive node control components 1264, the interactive node control components control a main display at each interactive node and communicates with and control each participant device at the interactive node.

In some embodiments, the interactive node control module 1122 may be integrated with other components in the coordination node. For example, interactive node control module 1122 may be integrated with a program control module 1214. In an embodiment that includes a coordination framework, the interactive node control module 1122 may be integrated, alternatively or additionally, be integrated with the central coordination components. In such embodiments, control of the main display

In various embodiments, the interactive node control module 1222 may operate in the same or a different location or the same or a different computing device than the coordination node. For example, in some embodiments, the interactive node control module may operate at a node within network 1210 and may communicate with the coordination node and with interactive nodes through the network. Some embodiments may include more than one interactive node control module with each interactive node control module controlling the operation of one or more interactive nodes.

In some embodiments, it may be desirable to provide one or more controller configuration modules that allow a participant device to be configured to operate in a particular manner to receive inputs from a participant. For example, it may be desirable to provide a configurable controller at a participant device that can be configured to provide different input controls such as buttons on the participant device for use during an interactive experience. The buttons and other controls can be configured to display a set of buttons that operate in a particular manner to allow a participant to enter information or otherwise provide inputs for an interactive experience.

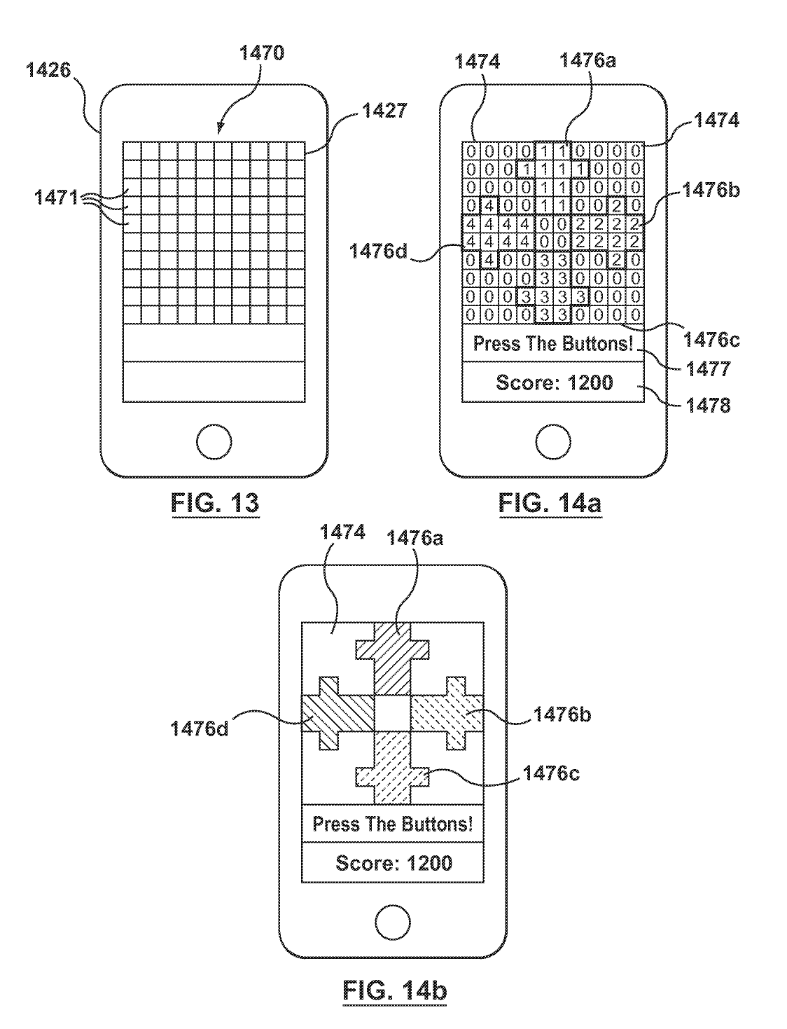

Reference is next made to FIG. 13, which illustrates a participant device 1426 showing an unconfigured button controller 1470. Button controller 1470 divides the secondary display screen 1427 of the participant device 1426 into a 10×10 grid of 100 grid elements 1471. Each grid element may be configured to operate in a particular manner during an interactive experience or part of an interactive experience.

FIG. 14a illustrates an example configuration of button controller into five regions 1474 and 1476a-d. Grid elements in region 1474, which includes a group of non-contiguous portions of the secondary display screen 1427, are identified by a value of 0 in each grid element. Grid elements in regions 1476a-d are identified corresponding values of 1, 2, 3 or 4 in each grid element of each region. FIG. 14b illustrates the configured button controller as it may appear to a participant on a participant device. The button controller 1470 is configured by defining various values or parameters in a configuration file. For example, a configuration file may include a listing or table, as exemplified in Table 1, indicating the region to which each grid element belongs. For each region, the configuration file may indicate a graphic or color to be displayed in or overlying the corresponding grid elements and operations that take place when a region in clicked by a user touching any grid element in the region. For example, a button controller configuration file may include the following values for the five regions 1474 and 1476:

TABLE 1
Configuration File To Configure Button Controller Into Five Regions

| | Display | | Action | |
|---|---|---|---|---|
| Region | Button_Up | Button_Pressed | On_Click | On_Release |
| 0 | — | — | — | — |
| 1 | Red_Bright.gif | Red_Dark.gif | Click_Red | — |
| 2 | Green_Bright.gif | Green_Dark.gif | Click_Green | — |
| 3 | Blue_Bright.gif | Blue_Dark.gif | Click_Blue | — |
| 4 | Yellow_Bright.gif | Yellow_Dark.gif | Click_Yellow | — |

When no grid element in any of regions 1476 is pressed, a graphic under the heading “Button_Up” is displayed in each region. In this example, the secondary display on the participant device displays a bright red graphic overlying the grid elements in region 1, a bright green graphic overlying the grid elements in region 2, a bright blue graphic overlying the grid elements in region 3 and a bright yellow graphic overlying the grid elements in region 4. When any one of the grid elements in a region is touched by a participant, a corresponding “Button_Pressed” graphic is displayed in that region. For example, if any grid element in region 2 is touched, a graphic in the file Green_Dark.gif is displayed.

When a grid element in a region is touched, an action under the heading On_Click is triggered. In this example, if a grid element in region 3 is touched by a participant, an action titled Click_Blue is triggered. In this example, no actions are triggered when a participant stops touching a button. In other cases, actions may be defined for additional aspects of the operation of a button. For example, display and action properties for button may be defined for a click-and-hold gesture, in which a participant touches and holds a button for a defined time. Other gestures for which display and action properties may be defined may include double-click, swiping, touch-and-hold, tap-and-then-hold, multifinger gestures and any other gestures or actions that the participant device is capable to sensing.

For region 1474, no display images or operation are defined, essentially making region 1474 an inactive or null region.

Some regions or portions of the secondary display screen may be provided in a button controller for specific purposes such as providing instructions to a participant or for providing information such as a score. In FIG. 14a, region 1477 is a text region and region 1478 is an information region. A text message to be displayed in region 1477 may be specified in a button controller configuration file. Similarly, information to be displayed in region 1478 may be specified in a button controller configuration file. The text message or information may be dynamic information that is modified during an interactive experience. For example, the content of these regions may be revised based on a participant's use of the button controller or actions during an interactive experience.

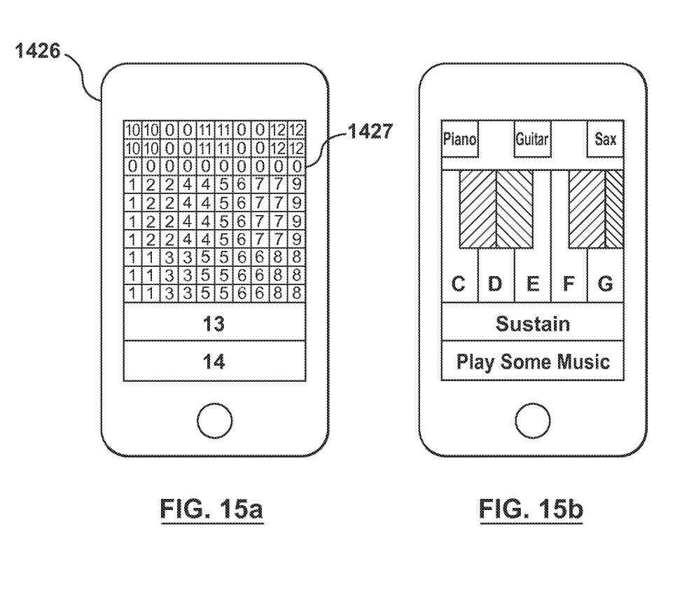

Reference is next made to FIGS. 15a and 15b which illustrate button controller 1470 with a different configuration. In this example, the button controller is configured as a set of piano keys 1576. Grid elements corresponding to each piano key are defined as a common region. FIG. 15a illustrates the assignment of grid elements to form regions corresponding to piano keys and other button elements. FIG. 15b illustrates the configured button controller as it may appear to a participant using a participant device. A configuration file for this configuration of button controller 1470 may include the following information, as exemplified in Table 2:

TABLE 2
Configuration File To Configure Button Controller Into Piano Keys

| | | | Action | |
|---|---|---|---|---|
| Region | Display | Text | On_Click | On_Release |
| 1 | White | “C” | Play “C” | End Sound |
| 2 | Black with | — | Play “C#” | End Sound |
| 3 | White | “D” | Play “D” | End Sound |
| 4 | Black | — | Play “D#” | End Sound |
| 5 | White | “E” | Play “E” | End Sound |
| 6 | White | “F” | Play “F” | End Sound |
| 7 | Black | — | Play “F#” | End Sound |
| 8 | White | “G” | Play “G” | End Sound |
| 9 | Black | — | Play “G#” | End Sound |
| 10 | Grey | “Piano” | Switch to | — |
| | | | Piano | |
| 11 | Gray | “Guitar” | Switch to | — |
| | | | Guitar | |
| 12 | Gray | “Sax” | Switch to Sax | — |
| 13 | Gray | “Sustain” | Activate | Release |
| | | | Sustain | Sustain |
| 14 | Gray | “Play Some Music” | — | — |

In this configuration, the appearance of each region remains constant when the corresponding grid elements are touched by a participant. When a grid element is touched a corresponding sound file based on a selected instrument is played until the participant stops touching the grid element. Regions 10, 11 and 12 trigger actions that change the particular sound files that will be played when any of regions 1 to 9 are touched by a participant. Region 13 provides a sustain function that results in a music file continuing to play even after the key that triggered the file is released. In effect, the sustain function suspends the “End Sound” action specified for the release of regions 1 to 9. Region 14 is configured as a text region to encourage a participant to play music using the controller. In some embodiments, the configuration file may include various options that affect the way in which a sound is played. For example, if a greater number of grid elements corresponding to a region are touched, then the corresponding sound file may be played at a louder volume. The pitch, timbre, attack, sustain, decay and other characteristics for each region may be defined in the configuration file and may vary depending on how a participant touches the various grid elements using various gestures.

Button controller 1470 may be configured in many other ways to provide different combinations and arrangements of regions, which may correspond to buttons when viewed by a participant. A participant may interact with the buttons with various gestures such as touching, holding, sliding, releasing and other gestures, in order to trigger corresponding actions.

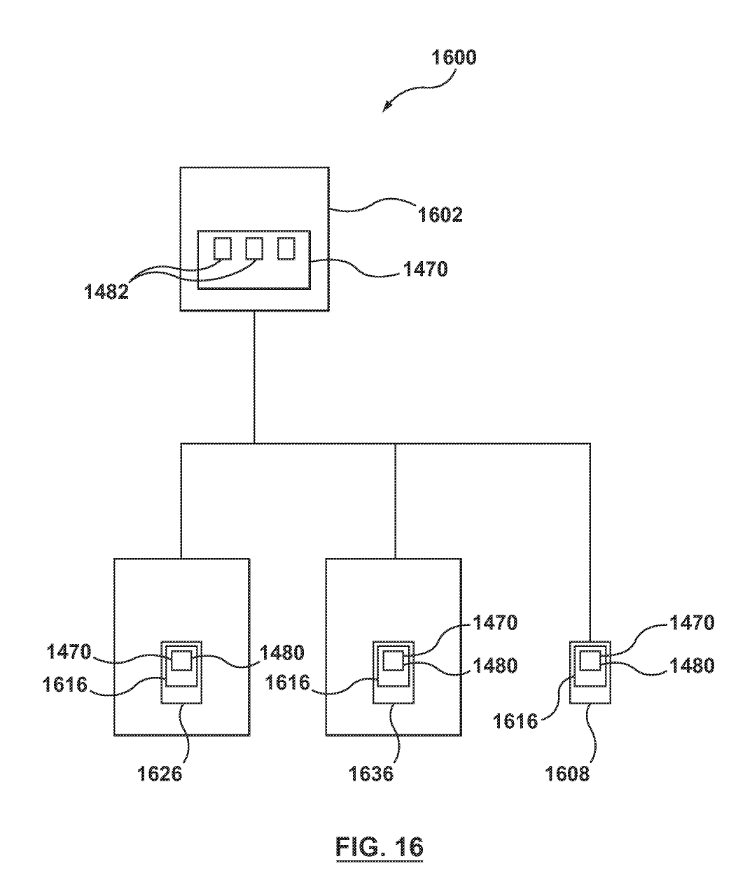

Reference is next made to FIG. 16, which illustrates the components of the button controller in an interaction system 1600. Interaction system 1600 includes a coordination node 1602 and a plurality of participant nodes 1608, 1626 and 1636 located in a variety of locations including private interactive nodes. In system 1600, a virtual local controller is provided in the coordination node.

Button controller 1470 includes one or more button controller interface components 1480. In some embodiments, each button controller interface is part of a system access application 1616 that is recorded in a non-transitory memory in the coordination node 1616. Each button controller interface component 1480 is configured to operate on one or more particular types of participant devices. For example, if a particular system access application is configured to operate on an Apple iPhone 4, then the button controller interface component 1480 in that system access application is correspondingly configured to operate on an Apple iPhone 4. This will typically require that the system access application and the button controller interface component are consistent with software, interface and other standards for the Apple iPhone 4. As described above, system 1600 may include a variety of system access applications corresponding to a variety of types of participant devices. Some or all of the system access applications may include a button controller interface component that is configured to operate on the corresponding type of participant device.

Button controller 1470 further includes one or more button controller configuration files 1482. A button controller configuration file 1482 configures a button controller interface component 1480 to operate in a specific manner, as described above. In various embodiments, a button controller configuration file 1482 may be adapted to configure one or more button controller interface components. For example, a common button controller interface configuration file may be used to configure a group of button controller interface components to appear and operate in a particular manner. For example, a group of button controller interfaces may be provided for different types of participant devices and the same button controller configuration file may be used to configure all of these button controller interfaces to operate in the same or a similar manner.

During operation of system 1600 to provide certain interactive experiences to a group of participants using participant devices, a button controller interface component corresponding to each participant device is installed on the participant device. Each button controller interface component 1480 is configured to operate in a desired manner using a corresponding button controller configuration file 1482.

In some embodiments, a suitable button controller interface component may be installed at each participant device 1626, 1636, 1608 as part of a system access application 1616 as described above in relation to step 1002 of method 1000 (FIG. 10). When a participant uses a participant device to participate in a particular interactive experience, a corresponding button controller configuration file 1482 is used to appropriately configure the button controller interface component 1480 to operate as desired for the interactive experience. If the button controller interface has been previously installed on a participant device prior to performing step 1002 (i.e. during a previous interactive experience or at another time that participant components for the interaction system were installed on the participant device), then the controller interface may be updated if necessary or it may be used as previously installed.

The specific button controller configuration file required to appropriately configure may be specified in an interactive application. During step 1004 of method 1000 (FIG. 10), the specified button controller configuration file may be transmitted to a participant device, together with any associated assets such as graphic files, sound files and other program, control or data assets or objects specified in the button controller configuration file. The system access application at the participant device may then configure the button controller interface component using the button controller configuration file. The associated assets may be used to configure the button controller or may be used to vary the display or operation of the button controller during an interactive experience.

In some embodiments, the participant device may discard a controller configuration file when an interactive experience ends. In such embodiments, the controller configuration file is transmitted to the participant device at the start of each corresponding interactive experience.

In this manner, the button controller may be installed on a variety of participant devices as part of a system access application in the form of an unconfigured button controller interface component, which is then configured as desired for a variety of interactive experiences. Creators of the interactive experiences may utilize existing configurations for the button controller or may provide a button controller configuration file that is specific to their interactive experiences. In some embodiments, such button controller configuration files may be provided in or with an interactive experience program. In some interactive programs, the configuration of a button controller may be varied during the program, or a participant may be permitted to choose between a variety of predetermined configuration or to design a personal configuration. Such options and selections made be a user may be recorded in a button controller configuration file stored on the participant's device. In some embodiments, multiple configuration files may be used to simultaneously to configure a button controller. For example, some aspects of a button controller may be configured based on a system provided configuration file that is specified in an interactive program while other aspects of the configuration are provided in a user specific configuration file stored on the participant device.

In some embodiments, a controller may be reconfigured dynamically during an interactive experience. The controller configuration file may include multiple configurations that can be interchanged during an interactive experience. In some embodiments, multiple configuration files may be transmitted to a participant device and an interactive program may specify which controller configuration file, and which part of a controller configuration file is to be used to configure a controller at any particular time. In some embodiments, controller configuration files and associated assets may be delivered to a participant device during an interactive experience, thereby adding to the number of configurations in which a controller may be used during an interactive experience.

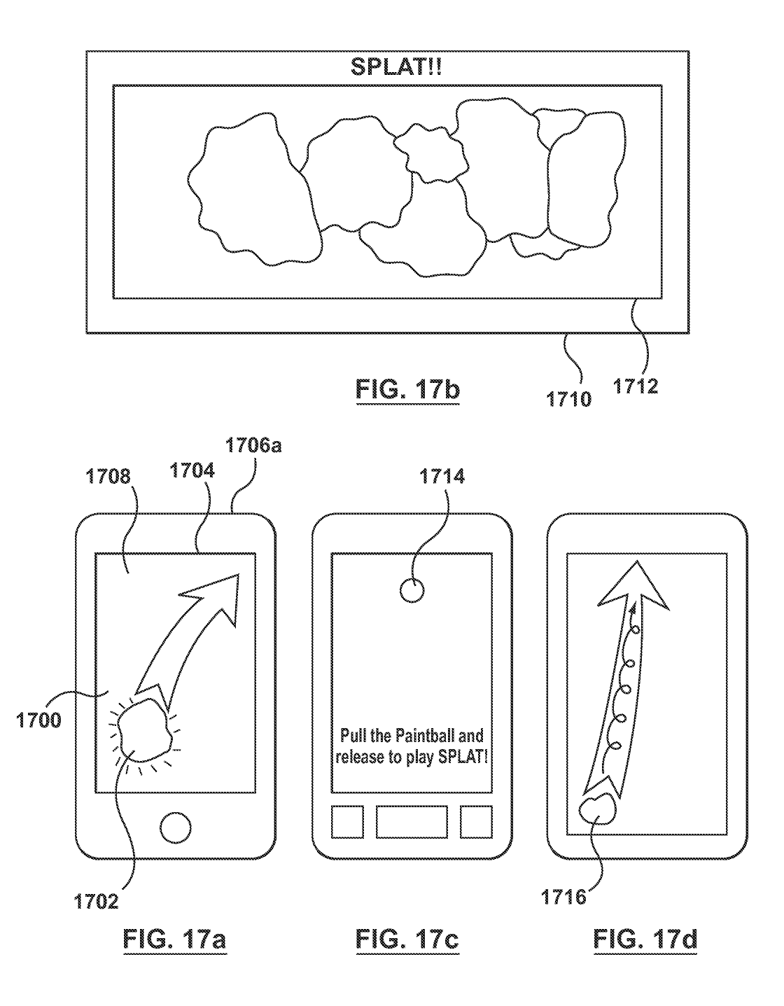

Reference is next made to FIG. 17a and FIG. 17b, which illustrates a toss controller 1700. Toss controller 1700 allows a virtual object to be directed in a particular direction. As illustrated in FIG. 17a, toss controller 1700 illustrates a paint ball for a “Splat” game in which a participant can toss a ball of colored paint onto a wall displayed on a main display. A paint ball 1702 may be moved by a participant by touching the ball in a pulling it downwards on the personal display 1704 on the participant device 1706. As the ball is held, it is displayed with greater size and motion to indicate that it has greater energy. When the participant releases the ball, it is displayed flying across the personal display towards the top of the secondary display 1708. As illustrated in FIG. 17b, the paint ball is then displayed on a main display 1710 flying onto and landing on a virtual wall 1712 on which other participant may similarly throw paint balls. As the paint ball lands in explodes and paint is shown being splattered onto the virtual wall. The direction, size and speed which the paint ball is thrown may depend on the gestures used by a participant to move the paint ball from its original position on the participant's secondary display prior to releasing the paint ball. FIG. 17c and FIG. 17d illustrate toss controller interface on other devices similarly configured to toss paintballs 1714 and 1716 onto the virtual wall 1712. The toss controller includes a plurality of toss controller interfaces that can be installed on a variety of participant devices. A toss controller configuration file can be used to configure the operation of some or all of these toss controller interfaces to provide the same or similar functions at each of the respective participant devices.

The toss controller has a variety of configurable characteristics, which can be controlled by different gestures. For example,
A background graphic may be defined for display behind other elements of the toss controller interface.
Various graphic elements may be defined including the size, shape, colour and actions of the tossed object. For example, one or more graphic assets, such as graphic files, instructions for generating a static or dynamic graphic object or other asset for providing or generating a graphic object.
Sounds may be defined to play while a participant takes various actions.
Controls for other components of participant devices, such as vibration devices. For example, if a player holds a paintball for a selected time, thereby giving a greater size or energy or both, the participant's device may begin to vibrate to further signify a paintball having greater energy.

In response to a participant's use of the toss controller, various data are transmitted to a coordination node from the participant's device, depending on the configuration of the toss controller. For example, a participant may be able to use a gesture to toss or throw an object with greater or lesser speed, impart spin to the tossed object by using a gesture or by touching the object in a particular manner or position. The toss controller configuration file may be used to define output data or parameters from the toss controller interface. Output data may be statically determined based on the participant's use of the configured toss controller interface displayed on the participant's device or may be dynamically determined. For example, the energy with which a paintball or other object is thrown may be dynamically determined by the length of time a participant holds the object before releasing, the speed with which the participant swipes the object across or along the secondary display screen on the participant's device or in another manner.

The output data from the controller corresponds to the participant's inputs to the controller. The central coordination components of an interactive program receive the output data and determine the resulting action or outcome in the interactive program. In some embodiments, the central coordination components may record the output data or a version of the output data.

Output data from a controller may be transmitted from a participant device to a local controller or to a coordination node in the same manner as other information that is transmitted during the operation of an interactive program.

The toss controller, like the button controller, can be configured or skinned to provide to appear and to operate differently.

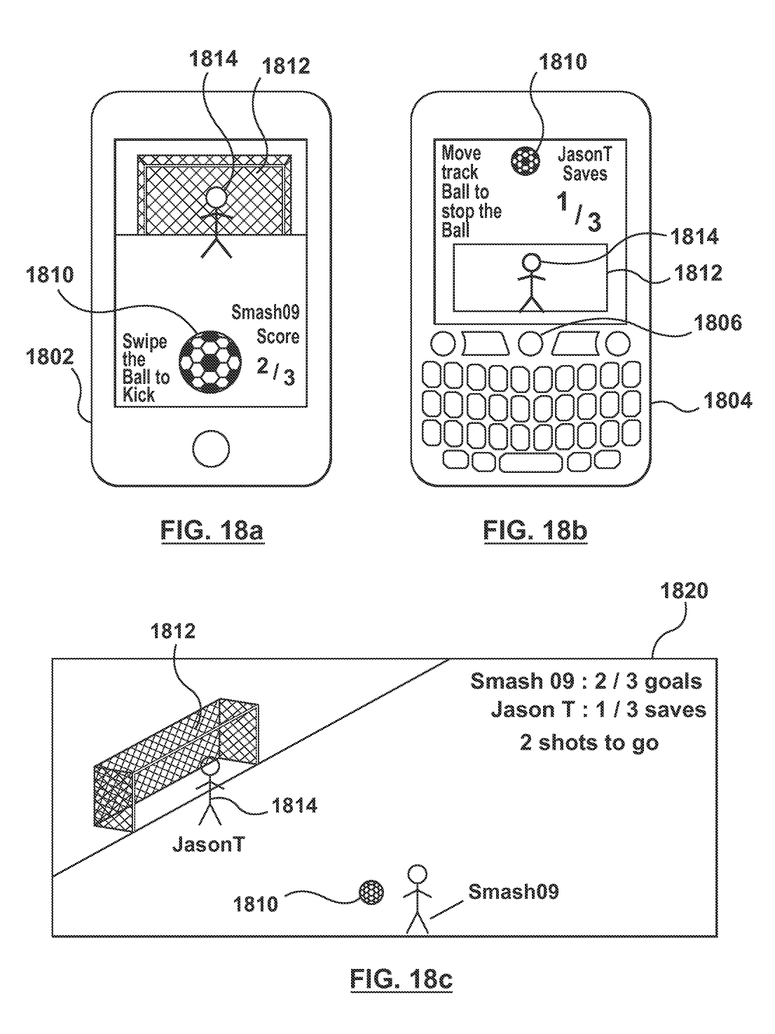

Reference is next made to FIGS. 18a-c. FIG. 18a illustrates a toss controller configured to allow a player to toss a soccer ball 1810 towards a soccer goal 1812 by swiping the ball on a personal display on the secondary display screen of the participant's device. During an interactive experience, a second participant may play the position of a goalkeeper 1814, as illustrated in FIG. 18b. The second participant can move the displayed goalkeeper back and forth and may use gestures to make the goalkeeper dive or jump to stop a soccer ball “kicked” by the first player. As illustrated in FIG. 18c, the interaction between the participant's may be displayed on a main display 1820 on a primary display screen 1824 that is visible to both participants and potentially to other participants and viewers in the same or other locations or both.

The toss controller may be used for both the soccer ball kicking configuration shown in FIG. 18a and for the goalkeeping configuration shown in FIG. 18b. In the soccer ball kicking configuration, the ball is tossed or kicked towards the goal keeper. In the goalkeeping configuration, the goalkeeper is moved or tossed across the face of the goal in an attempt to stop the ball. The respective toss controller interfaces on each of the participant devices receive inputs from the respective users. In FIG. 18a, the participant device 1802 has a touchscreen 1803 and the participant uses a swipe gesture to direct the ball and to kick it with greater or lesser speed and spin. In FIG. 18b, the participant device 1804 has a trackball 1806 that the participant uses to move the goalkeeper. The toss controller configuration file used to configure the toss controller interface on each participant device may include configurations for both the soccer ball kicking configuration and for the goalkeeper configuration. The particular configuration displayed at any particular time is determined by the interactive program in which a player is participating. For example, the central components of the soccer interactive program may designate one participant to be the shot-taker and the other participant to be the goal keeper. These designations, which may be made in response to player inputs, are communicated to the respective participant components at the respective participant devices, which then execute corresponding software and other components, including the toss controller interface configured with the appropriate configuration file or portion of a configuration file. Typically, the central components of the interactive program, which coordinate the interactions between participants in an interactive experience and the respective displays on the main displays and secondary displays on participant devices will provide instructions to the participant components on each participant device to control and allow for the participant's participation in the interactive experience. In the present soccer example, the central components receive data about the kicking participant's kick of the soccer ball and the goalkeeping participant's movement of the goalkeeper to prevent the ball from entering the goal. The central components communicate with the participant components at each participant node and the main display or displays visible to the players to show the outcome of the respective player's movements. At some point, the roles of the players may be reversed under the control of the central components. The change of roles is communicated to the participant components at the respective participant devices, which then respond by changing the configuration of the toss controller at each participant device.

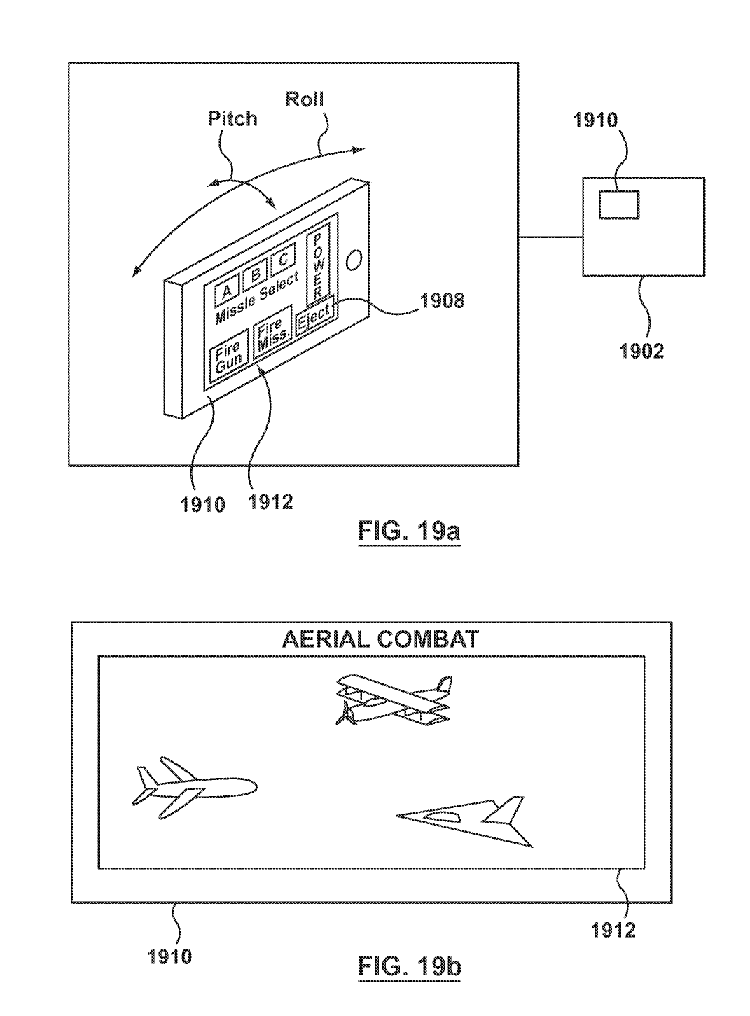

Reference is next made to FIGS. 19a-b, which illustrates a gyroscope controller 1910. Some participant devices include gyroscope and other sensors that allow the orientation of a device or changes in the orientation of a device to be sensed. The gyroscope controller 1910 includes gyroscope controller interface components that can be installed at such participant devices to convert such movements into output data that is transmitted to a coordination node 1902 that coordinates inputs from various participants. FIG. 19a illustrates a gyroscope controller interface 1912 configured as an airplane controller. FIG. 19b illustrates a main display showing various aircraft engaged in aerial combat as part of an aerial combat interactive program. Controller interface detects rotation of the participant device about various axes as pitch and roll inputs for an aircraft. The greater the rotation, the greater the pitch or roll is determined to be. A gyroscope controller configuration file may specify the relationship between rotation of the participant device and the amount of the pitch or roll. The relationship could be specified in a fixed manner, for example, through the use of a look up table, or in a dynamic manner, for example, through the use a calculation. The amount of pitch and roll for the participant device is reported to the central components for the aerial combat interactive program as output data. In addition to the gyroscope inputs, the secondary display screen 1908 if the participant device 1906 shows a personal display that includes various buttons and slider that allow a participant to control an aircraft, including a power slider, a gun firing button, a missile selection button, a missile firing button and an eject button. The gyroscope controller may include a button configuration feature similar to that described above in relation to the button controller. In such an embodiment, both the gyroscope sensor and the touchscreen would be configurable using a gyroscope controller configuration file. For participant devices that include physical buttons or other input devices, the gyroscope controller configuration file may also be used to configure the use of some or all of those input devices for use with an interactive program, in accordance with guidelines for the use of input devices for such participant devices.

Gyroscope controller 1910 is an example of a controller that uses input devices in a participant devices other than a touchscreen or a button or cursor (i.e. trackball or control wheel) interface. Various embodiments of controllers may allow for any type of input device or sensor in a participant device to be configured for use with an interactive experience. For example, temperatures sensors, humidity sensors, light sensors, proximity sensors, external sensors coupled to participant device through a wired or wireless coupling and any other type sensor may be configured for use with an interactive experience.

In some embodiments, several controllers may be operative at a participant device simultaneously. For example, in some embodiments, a gyroscope controller may provide for sensing and reporting of data only from a gyroscope sensor (or other orientation detection sensor). A button controller may be operative at the same time as a gyroscope controller at a participant device to provide buttons and sliders to allow a participant to provide inputs using virtual buttons on a touchscreen or using physical buttons on the participant device. Output data may be combined by participant components and transmitted to central components of an interactive program or output data from the different controllers may be independently transmitted to the central components.

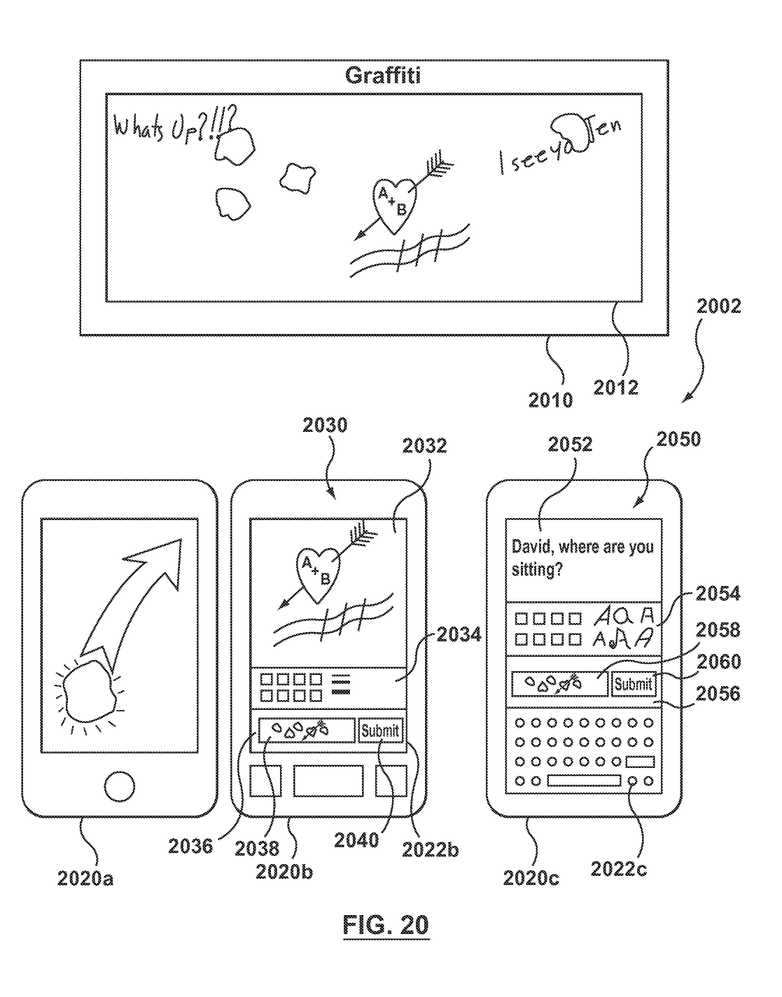

Reference is next made to FIG. 20, which illustrates portions of another interaction system 2002 that includes several participant devices 2020a-c and a main display 2010 at an interactive node. System 2002 also includes a coordination node that is not illustrated. Main display 2010 illustrates a virtual wall 2012, similar to the virtual wall 1712 of FIG. 17 that is shared among various participants as part of a Graffiti interactive experience. Various types of rendered objects may be added to the virtual wall by participants using participant controllers in an interactive experience. Participant device 2020a is configured to operate as a toss controller that allows paintballs to be thrown onto the virtual wall, as described above.

Participant device 2020b illustrates a trace controller 2030. Trace controller configuration files are used to configure trace controller interfaces installed at various participant devices, as with the other controller described herein. In FIG. 20, the secondary display screen 2022b of participant device 2020b is configured to be divided into a drawing region 2032, a pallet region 2034 and a navigation region 2036. Navigation region 2036 illustrates a small image 2038 of a portion of the virtual wall 2012. A participant may move the illustrated portion of a virtual wall by sliding the virtual wall in the navigation window. The navigation region also includes a submit button 2040. Drawing region 2032 is used by a participant to draw graphic objects, which may includes drawings, words or any other object that may be drawn using a finger, trackball or other tools (such as a stylus) that are compatible with the participant device. The participant may use tools in the pallette region 2034 to select various drawing tools which may provide different colors, line shapes, etc. that the participant may use to make a drawing. When the participant has completed a drawing, the participant can move the virtual wall shown in navigation region 2036 to a desired position and touch the Submit button 2040. The participant's drawing is transmitted to central components of the Graffiti interactive program, which then add the drawing to the virtual wall and update the main display at one or more interactive nodes to show the participant's drawing.

The trace controller may be used in a variety of interactive experience. In system 2002, the trace controller is used to generate drawings for the Graffiti interactive experience. The trace controller may also be configured for other interactive experiences. For example, the trace controller could be configured for a document markup interactive experience. Trace controllers on various participant devices at one or more interactive nodes may be configured to illustrate a text or other document underlying a drawing region and the various participants may be able to view and mark up the document to suggest changes or for other reasons. The participants may simultaneously be engaged in a text chat, voice chat or other live communication that allows them to discuss various markups and thus simultaneously and interactively mark up the document.

A trace controller configuration file is used to configure the trace controller for various interactive experiences. In an unconfigured form, the trace controller may have a defined trace drawing region and may provide various pallette, navigation or control tools, all of which may be configured in the trace controller configuration file.

Participant device 2020c illustrates a word controller 2050. Word controller configuration files are used to configure trace controller interfaces installed at various participant devices, as with the other controller described herein. In FIG. 20, the secondary display screen 2022c of participant device 2020c is configured to be divided into a writing region 2052, a styles region 2054 and a navigation region 2056. Navigation region 2056 is similar to navigation region 2036 and illustrates a small image 2058 of a portion of the virtual wall 2012. A participant may move the illustrated portion of a virtual wall by sliding the virtual wall in the navigation window. The navigation region also includes a submit button 2060. Drawing region 2052 is used by a participant to create text objects, which may include any stylized or simple text that may be written using a virtual or physical keyboard or other tools (such as a stylus) that are compatible with the participant device. The participant may use tools in the style region 2054 to select fonts, colors and text effects to embellish or modify the participant's text. When the participant has completed a text object, the participant can move the virtual wall shown in navigation region 2056 to a desired position and touch the Submit button 2060. The participant's drawing is transmitted to central components of the Graffiti interactive program, which then add the drawing to the virtual wall at the location selected by the participant and update the main display at one or more interactive nodes to show the participant's drawing.

The word controller may be used in a variety of interactive experiences. For example, the trace controller could be configured for a document editing interactive experience. Word controllers on various participant devices at one or more interactive nodes may be configured to edit a text documents. Various participants may be able to view and edit the document to suggest changes or for other reasons. The participants may simultaneously be engaged in a text chat, voice chat or other live communication that allows them to discuss various markups and thus simultaneously and interactively mark up the document. In some embodiments, the trace and word controllers may be combined or may be used simultaneously be various participants to simultaneously mark up and edit a text document.

A word controller configuration file is used to configure the word controller for various interactive experiences. In an unconfigured form, the word controller may have a text editing region and may provide various pallette, navigation or control tools, all of which may be configured in the trace controller configuration file.

System 2002 illustrates the simultaneous use of the splat, trace and word controllers in a common Graffiti interactive experience. In some embodiments, the participant components of the interactive experience may provide one or more controls to allow a participant to select different controller for use during an interactive experience. For example a participant may wish to switch between adding drawings to the virtual wall and through paintballs on to the virtual wall to obscure drawings added by other participants.

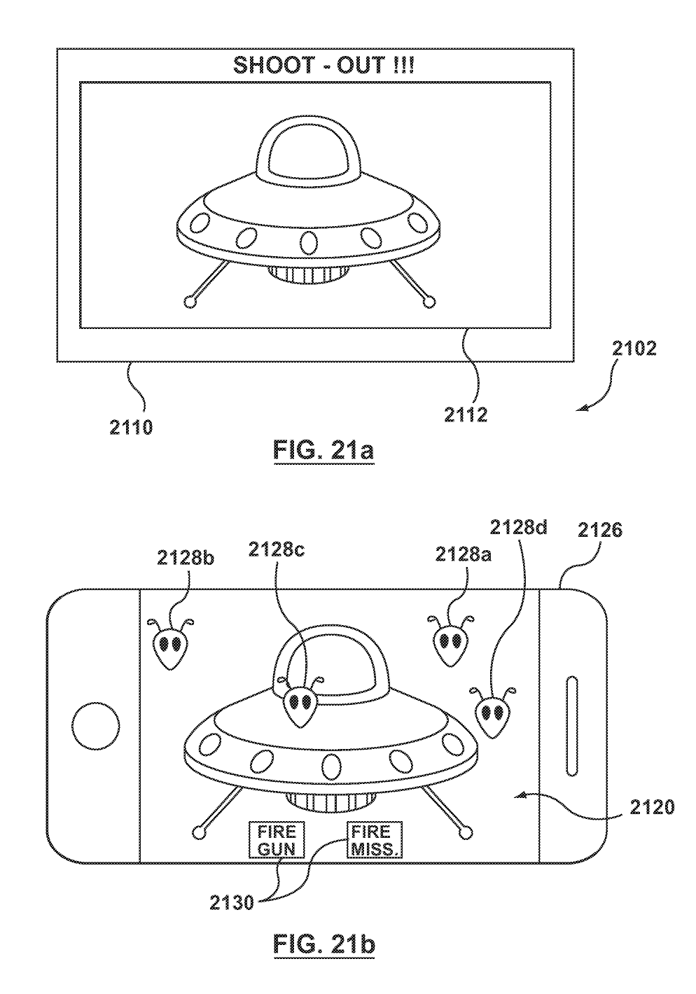

Reference is next made to FIGS. 21a-b, which illustrate portions of interaction system 2102 that includes a participant device 2126 and a main display 2110 at an interactive node. System 2102 also includes a coordination node that is not illustrated. Main display 2110 illustrates a virtual wall 2112, similar to the virtual wall 2012 of FIG. 20 that is shared among various participants as part of a Shoot-out interactive experience.

Participant device 2126 illustrates an augmented reality controller 2120. Most participant devices include a photo/video camera and a viewfinder that allows the participant device to display what is in front of the camera. In some other cases, the participant device may include other ways of detecting or capturing what is in front of the participant device. Augmented reality controller may use images from the camera to determine the position and orientation of the participant device relative to a main display 2110. For example, the main display may include registration marks or elements that can be detected in an image taken by the camera of a participant device. An augmented reality controller may identify the registration marks or element in the image to determine the position and orientation of the participant device relative to the main display. In other embodiments, the augmented reality controller may use any portion of a main display to determine the position and orientation of a participant device.

Augmented reality controller 2120 allows for superimposition of virtual content on top of the content displayed on the main display 2110 if the participant device is held up to view the main display 2110. For example, during an interactive experience, if a participant holds up their participant device configured with augmented reality controller 2120 to view the main display 2110, the secondary display of the participant device display may include some or all of the content seen on the main display 2110 but also additional content customized for the participant device.

The augmented reality controller 2120 includes one or more augmented reality controller interface components that are configured to operate on one or more particular types of participant devices.

The augmented reality controller 2120 further includes one or more augmented reality controller configuration files. The configuration files configure the augmented reality controller interface components to operate in a specific manner. During operation of system 2102 to provide certain interactive experiences to a group of participants using participant devices, an augmented reality controller interface component corresponding to each participant device is installed on the participant device. Each augmented reality interface component is configured to operate in a desired manner using a corresponding augmented reality controller configuration file.

The configuration file may configure the augmented reality controller to detect when a participant device 2126 is held up to view the main display 2110. This may be based on factors such as, for example, spatial coordinates and orientation of the participant device with respect to the main display, which may be determined in various manner, including the use of elements of the main display as described above. In some embodiments, the participant device may detect that it is held up to view the main display, and communicate a request to enter augmented reality to the local controller. In some other embodiments, the spatial coordinates and the orientation of the participant device may be communicated to the local controller, where the local controller determines whether or not the participant device has been held up in the acceptable range of spatial coordinates and orientation to view the main display and whether augmented reality can be entered.

When augmented reality is entered, the display of the participant device displays additional content superimposed on top of the content seen in the primary display 2110. In various cases, the additional content is customized for the participant device.

FIG. 21a illustrates a main display illustrating an extra-terrestrial spaceship that is a part of a shoot-out interactive experience. FIG. 21b illustrates an augmented reality controller 2120 configured as a shoot-out controller, where the controller is held up to view the main display. FIG. 21b further illustrates the augmented reality controller 2120 displaying superimposed alien targets 2128a-d for the participant to shoot. The superimposed alien targets 2128a-d may be planted differently for different participants and accordingly, the displays of other participant devices may show different positioning of the alien targets. In some cases, the alien targets may be planted based on the team the participant device belongs.

FIG. 21b also illustrates a simultaneous use of an augmented reality controller 2120 and a toss controller 2130. The participant can toss bullets from a gun or missile onto the superimposed alien targets. The bullets may be moved by the participant by touching gun or missile options, and tossing them towards the alien targets. In some other embodiments, other controllers, such as button controllers, may be used along with the augmented reality controllers to shoot at the alien targets. In some further embodiments, a voice controller (not shown) may be simultaneously used with the augmented reality controller 2120. The voice controller may enable the participants to fire arms and ammunitions by speaking into the corresponding participant device. For example, the participant may say “Fire Gun” or “Fire Missile” to cause the participant device to fire bullets from a gun or a missile to the alien targets.

Typically, the central components of the interactive program, which coordinate the interactions between participants in an interactive experience and the respective displays on the main displays and secondary displays on participant devices, will provide instructions to the participant components on each participant device to control and allow for the participant's participation in the interactive experience. In the present example, the central components receive data about the shooting of the alien targets. The central components communicate with the participant components at each participant node to show the outcome of the respective player's movements.

The controllers described above have been described in the context of multi-location interaction systems. In various embodiments, the controllers may be used in an interaction system that is operable at a single interactive location only, such as a movie theater or sporting venue where all participants are in a single location sharing a common main display (or multiple main displays that are positioned to allow participants in different locations in the venue to see one of the main displays, such as main displays on different sides of a scoreboard in a sporting venue).

Various controllers may permit the frequency at which output data from a controller interface at a participant device is transmitted to central coordination components for an interactive experience at a coordination node. For example, in system 2002, drawings and text from respectively, the trace controller and the word controller, are transmitted when the respective Submit buttons are touched. In other embodiments, the components of a drawing or a text objects may be transmitted as they are created or periodically (such as every 100 or 500 ms or every few seconds) such that viewers of the main display can observe drawings and text objects as they are created or modified. Various actions may be used to trigger the transmission of output data relating to some or all of the inputs provided at a controller interface. For example, the use of a submit button, a period of time, such as every few seconds or minutes or any other time period, when any input is provided (such as a change in the position of a participant device when the gyroscope controller is used). In some embodiments, the central coordination components of an interactive program may query a controller interface at a participant device to obtain updated output data from the participant device. In some embodiments, some or all of these update triggers may be combined.

Each of the controller described above may be installed on a participant device and configured as described in relation to the button controller and the other controllers. The features of the various controllers may be combined to form new controllers or hybrid controllers. In some cases, an interactive program may allow multiple controllers to be used to participate in an interactive experience. For example, a participant that prefers to use a touchscreen may use a controller that is configured to provide buttons and other inputs on a screen while a participant who prefers to use physical buttons or physical movement of a participant device may use a suitably configured controller for the same interactive experience. All of these controllers could be provided for the same participant device, allowing a participant to use a controller that the participant prefers for a particular interactive experience. The use of controllers at the participant devices, under the control of interactive programs, allows producers of interactive programs to make use of one or more pre-designed controllers that can be configured to provide specific input and output functions required for the interactive programs.

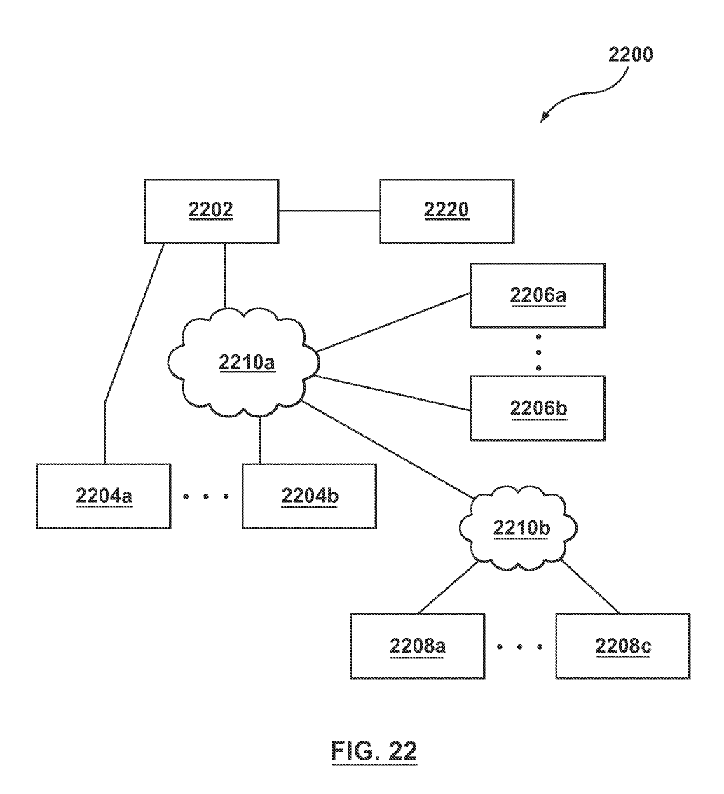

Reference is next made to FIG. 22, which illustrates an interaction system 2200 comprising an operator console 2220. Operator console is a controller configured to coordinate the interactive experiences of all participants based on participant feedback. The operator console may be a human administrator or operator, or a virtual component operating on a computer.

The operator console may be further configured to determine the course of the interactive experience, i.e. the manner in which the interactive experience progresses or evolves. For example, the operator console may be configured to start the interactive experience, interrupt the interactive experience and end the interactive experience etc. based on participant feedback.

The operator console may be further configured to determine which interactive experience to initiate, such as, for example, which game to launch for playing, or which advertisement to launch for viewing etc.

The operator console may also determine when to poll the participants to receive feedback on the interactive experiences. The participant feedback may be displayed in real-time, or the poll results may be aggregated and displayed at a later time. The operator console may also select certain participant feedback for display to some or all participants.

FIG. 22 illustrates an interaction system 2200 including a coordination node 2202, an operator console 2220, a plurality of public multi-participant interactive nodes 2204, a plurality of private multi-participant interactive nodes 2206, and a plurality of individual interactive nodes 2208. Each interactive node 2204, 2206, and 2208 in system 2200 communicates with coordination node 2202 through network 2210, which may include any type of communication network or network components, such as wide area network 2210a such as the Internet. Network 2210 may also include other types of communication network 2210b, such as a direct point-to-point connection, a cellular communications network, a satellite based communication network, a local area network or any other type of communication network or system. In some cases, the interactive nodes, such as public node 2204a, may communicate directly with the coordination node 2202. In some embodiments, some of the interactive nodes may communicate directly between themselves through network 2210.

Operator console 2220 is coupled to the coordination node 2202 directly or indirectly through network 2210. As previously mentioned, the term “coupled” means that two or more devices are able to communicate such that data and other information can be transmitted between them. The operator console 2220 is configured to make determinations regarding the interactive experience and communicate them to the coordination node 2202. Based on the determinations, the course of the interactive experience may be interrupted, altered or allowed to continue.

For example, in a movie theater venue, the operator console 2220 may determine the popularity of the ongoing interactive experience. The popularity of the ongoing experience may be determined based on certain factors, such as, for example, by monitoring the number of new participants joining in the experience, the number of participants leaving the experience, the type of feedback received from the participants etc. The operator console 2220 may determine that the current interactive experience is not very popular with the participants. In response, the operator console 2220 may cause the experience to change by, for example, shortening the interactive experience, introducing opportunities within the experience to win rewards, switching to the scoreboard to motivate the participants etc. The operator console 2220 communicates decisions regarding the selected course of the interactive experience to the coordination node 2202. The coordination node 2202 coordinates and synchronizes the interactive experience shared by the interactive nodes.

The operator console 2220 may be deployed in the cloud, such as, for example, a public cloud, a private cloud or a hybrid cloud, and configured to control all downstream interactive experiences.

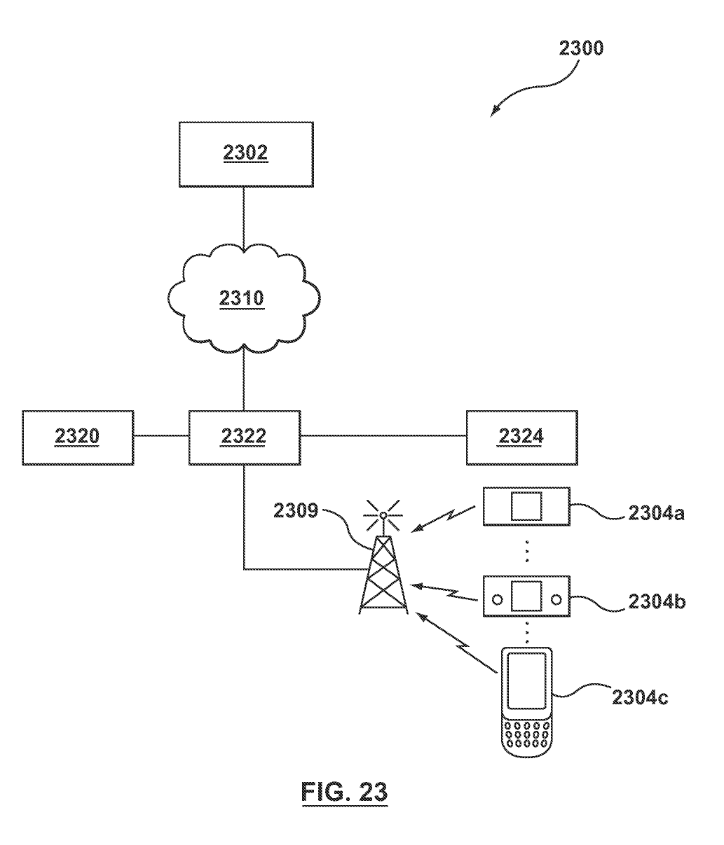

Reference is next made to FIG. 23, illustrating another example deployment of the operator console in interaction systems 2300. FIG. 23 illustrates a public multi-participant interactive node or a public node. Although not shown, the operator console 2320 can be similarly deployed in other types of interactive nodes, such as, for example, a private or individual node.

Public node includes a local controller 2322, an operator console 2320, a primary screen 2324 and a plurality of participant devices 2304a, 2304b and 2304c. Local controller 2322 is coupled to coordination node 2302, directly or indirectly, through network 2310. Local controller 2322 is coupled to the participant devices via local network 2309 available at the public venue. The local network 2309 may be a wireless network such as a Wi-Fi network, a Bluetooth network or any other type of communication network or system. The operator console 2320 is coupled to the local controller 2322 either directly or indirectly through network 2309.

The operator console 2320 may determine the course of the interactive experience by making determinations specific to the particular node in which it is deployed. For example, in a movie theater venue, the operator console 2320 may determine the direction of the interactive experience by determining which game to initiate. This may be determined based on factors, such as, for example, gender distribution of the participants, age group of the participants etc.

The operator console 2320 communicates the decided course of the interactive experience to the local controller 2322. The local controller 2322 may synchronize the interactive experience with the coordination node 2302, and control the display of the primary screen 2324 and participant devices 2304a, 2304b and 2304c.

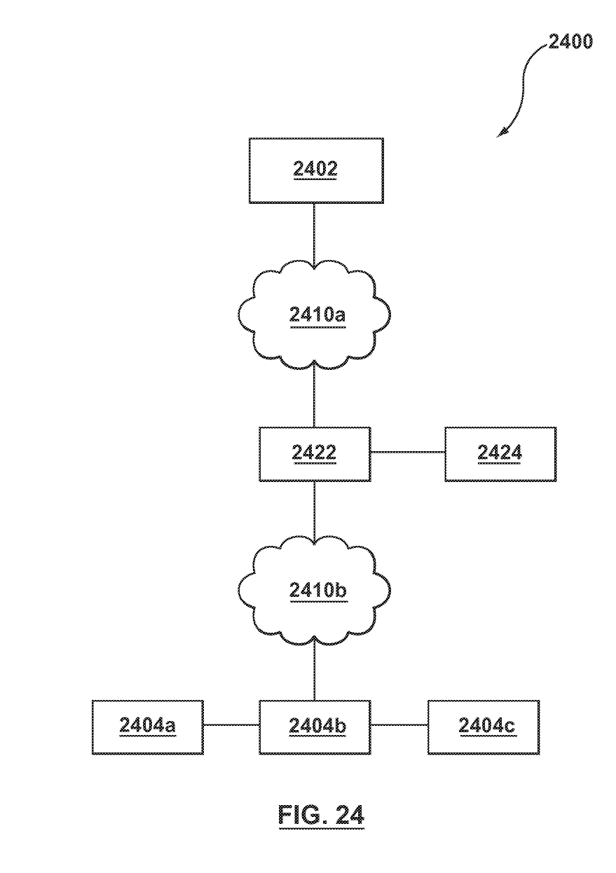

Reference is next made to FIG. 24, illustrating an interaction system 2400 comprising an operator console 2420 in another example deployment. FIG. 24 illustrates a public node comprising a local controller 2422, an operator console 2420, and a plurality of participant devices 2404a, 2404b and 2404c coupled to the local controller via network 2410b. Network 2410b may include any type of communication network, such as a local area network, a direct point-to-point connection etc. The local controller 2422 is coupled to the coordination node 2402 via network 2410a, such as a wide area network. The operator console 2420 is coupled to the individual participant devices 2404a, 2404b and 2404c, either directly or indirectly through network 2410b.

Although not shown, the operator console 2420 can be similarly deployed in other types of interactive nodes, such as, for example, a private or individual node.

The operator console 2420 may be configured to determine the course of the interactive experience by determining when the participant devices 2404a, 2404b and 2404c and/or the primary screen 2424 displays the scoreboard or when the participants are polled for feedback etc. As previously mentioned, the operator console 2420 may also decide when to stop the interactive experience, which interactive experience to start and when to interrupt the interactive experience etc. In some embodiments, an interaction system comprises more than one operator consoles. The multiple operator consoles may be deployed at the same location, or different locations within the interaction system. For example, in some cases, one operator console may be coupled to the coordination node, such as in FIG. 22, and another to the participant devices, such as in FIG. 24.

The present invention has been described here by way of example only. Various modification and variations may be made to these exemplary embodiments without departing from the spirit and scope of the invention.

1. A multiple location interaction system comprising:
a coordination node;
a plurality of interactive nodes; and
a network coupling the coordination node to each of the interactive nodes.

2. The system of claim 1 wherein at least some of the interactive nodes are public nodes and wherein at least one of the public nodes comprises:
a primary display screen for displaying a main display; and
a public node local controller configured to be coupled to one or more participant devices, each participant device having a secondary display screen for displaying a personal display.

3. The system of claim 2 wherein at least two public nodes share a public node local controller.

4. The system of claim 2 wherein a plurality of interactive nodes are provided at a location and wherein some of the interactive nodes provided at the location share the public node local controller.

5. The system of claim 1 wherein at least some of the interactive nodes are private nodes and wherein at least one of the private nodes comprises:
a private node local controller configured to be coupled to one or more participant devices, each participant device having a secondary display screen for displaying a personal display; and
a primary display screen coupled to the private node local controller and configured to display a main display.

6. The system of claim 5 wherein the private node local controller of at least one of the private nodes is a gaming system console configured to operate as a private node local controller.

7. The system of claim 1 wherein a local controller for at least some of the interactive nodes is a virtual component.

8. The system of claim 7 wherein the local controller is a virtual component shared between multiple interactive nodes.

9. The system of claim 1 wherein at least one of the plurality of interactive nodes is an individual interactive node having display screen for displaying a main display and a personal display.

10. The system of claim 9 wherein the main display and person display are displayed simultaneously on the display screen of the individual interactive node.

11. The system of claim 9 wherein the main display and person display are displayed alternatively on the display screen of the individual interactive node.

12. The system of claim 1 wherein the coordination node comprises a program database for recording one or more interactive programs.

13. The system of claim 12 wherein at least some of the interactive programs recorded in the program database comprises one or more central components and one or more participant components.

14. The system of claim 12 wherein at least some of the interactive programs further comprise local controller components.

15. The system of claim 1 wherein the coordination node comprises one or more program control modules.

16. The system of claim 1 wherein the coordination node comprises one or more system access applications.

17. The system of claim 1 to wherein the coordination node comprises a participant database for recording participant records containing information about one or more participants.

18. A method of providing an interactive experience to two or more participants located at one or more interactive nodes, the method comprising:
providing a program control module to manage the interactive experience;
providing an interactive program having participant components and central components;
providing at least some of the participant components to a plurality of participant devices, wherein each participant device is used by one of the participants to participate in the interactive experience;
providing at least one main display at each interactive node such that at least one main display is visible to each participant; and
providing a personal display on each of the participant devices.

19. The method of claim 18 further comprising providing an interactive experience for at least one of the participants based on demographic information recorded in the participant's participant record.

20. The method of claim 18 further comprising providing an interactive experience for each of the participants based on demographic information recorded in the participant's participant record.

21. The method of claim 18 wherein at least one of the interactive nodes is an individual interactive node having display screen for displaying a main display and a personal display.

22. The system of claim 21 wherein the main display and person display are displayed simultaneously on the display screen of the individual interactive node.

23. The system of claim 21 wherein the main display and person display are displayed alternatively on the display screen of the individual interactive node.

24. The method of claim 18 further comprising coordinating the interactive experience by transmitting program update messages between interactive nodes and a coordination node.

25. The method of claim 18 further comprising coordinating the interactive experience in response to inputs from some or all of the participants.

26. The method of claim 18 wherein at least one of the interactive nodes is configured as an operator console.
